(19) United States
(12) Patent Application Publication
(10) Pub. No.: US 2025/0259311 A1
(43) Pub. Date: Aug. 14, 2025

(54) UNSUPERVISED REGION-GROWING NETWORK FOR OBJECT SEGMENTATION IN ATMOSPHERIC TURBULENCE

(71) Applicant: Arizona Board of Regents on Behalf of Arizona State University, Scottsdale, AZ (US)

(72) Inventors: Dehao Qin, Goose Creek, SC (US); Ripon Kumar Saha, Tempe, AZ (US); Suren Jayasuriya, Chandler, AZ (US); Jinwei Ye, Fairfax, VA (US); Nianyi Li, Clemson, SC (US)

(21) Appl. No.: 19/044,229

(22) Filed: Feb. 3, 2025

Related U.S. Application Data
(63) Continuation of application No. 63/551,309, filed on Feb. 8, 2024.

(51) Int. Cl. G06T 7/187; G06T 7/174; G06T 7/215; G06T 7/246

(52) U.S. Cl. CPC G06T 7/187; G06T 7/174; G06T 7/215; G06T 7/246; G06T 2207/10016; G06T 2207/20081; G06T 2207/20084

(57) ABSTRACT

An unsupervised region-growing network (RGN) is trained to perform object segmentation on video data degraded by atmospheric turbulence. The method includes obtaining input data containing turbulence-degraded video, extracting a video frame sequence, and training the RGN using a selected algorithm incorporating a region-growing algorithm and a grouping loss function. A bidirectional optical flow sequence is computed for multiple reference frames within the video sequence. Pixel-level masks are generated for detected moving objects, followed by applying the region-growing algorithm to create coarse masks. A grouping loss function refines these masks to ensure consistency across consecutive frames. The trained RGN outputs refined masks as object segmentation data for the received video, improving segmentation accuracy in turbulent environments. This approach enables robust object detection and segmentation without requiring prior video restoration, maintaining fidelity to the original turbulence-distorted input.

### CLAIM OF PRIORITY

This application claims the benefit of U.S. Patent Application No. 63/551,309, filed 8 Feb. 2024, the entire contents of which is incorporated herein by reference.

### GOVERNMENT RIGHTS AND GOVERNMENT AGENCY SUPPORT NOTICE

This invention was made with government support under grant number 2232300 awarded by the National Science Foundation. The government has certain rights in the invention.

### TECHNICAL FIELD

Aspects of the invention relate generally to the field of artificial intelligence and machine learning via computational systems and more particularly, to systems, methods, and apparatuses for implementing an unsupervised region-growing network for use with object segmentation in atmospheric turbulence.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

Machine learning models have various applications to automatically process inputs and produce outputs considering situational factors and learned information to improve output quality.

Foreground and background segmentation plays a pivotal role in various general computer vision tasks including surveillance, remote sensing, and environmental monitoring. However, in long-range imaging for outdoor environments, particularly when using high focal length cameras, substantial image distortions due to atmospheric turbulence limit the effectiveness of segmentation methods. These image distortions obscure crucial details such as the distinct separation between foreground and background elements, and the blurring and distortion of moving objects in dynamic scenes hinders reliable segmentation and tracking. Both data-driven and unsupervised foreground-background segmentation tasks are known to fail in such scenarios.

### SUMMARY

In general, this disclosure is directed to systems, methods, and apparatuses for implementing an unsupervised region-growing network for use with object segmentation in atmospheric turbulence.

While state-of-the-art segmentation methods have achieved remarkable success in stable environments, these methods typically rely on advanced machine learning techniques and vast annotated datasets for training. However, such supervised methods cannot adapt to varying degrees of turbulence. Moreover, prior known supervised methods depend on extensively labeled data which may not be available. Hence, opting for an unsupervised video object segmentation method seems promising. Many existing unsupervised methods heavily rely on optical flow which can be degraded by atmospheric turbulence. Consequently, even the most recent state-of-the-art does not accurately segment turbulence-distorted moving objects from the background.

To overcome the aforementioned challenges, a two-stage unsupervised moving segmentation algorithm is presented herein. The techniques of this disclosure may be configured for dynamic scenes affected by atmospheric turbulence. The methodology set forth herein embraces the principle that rigid motion and turbulence have differing temporal cues which can be leveraged to maintain the spatial relationship and structure consistency of moving objects among different frames. The described methodology generates optimized and robust optical flow feature maps which are resilient to the effects of turbulence. The optical flow feature maps, once generated, are utilized to produce initial coarse masks for each object in every frame. To further enhance mask accuracy, a refinement network accepts the coarse maps as input and operates to improve spatiotemporal consistency of the coarse masks.

In at least one example, processing circuitry is configured to perform a method that includes using an unsupervised region-growing network to perform object segmentation for video data degraded by atmospheric turbulence. According to certain examples, the method includes obtaining input data including the video data degraded by atmospheric turbulence. In at least one example, the method includes extracting a video frame sequence from the video data. According to such examples, the method includes training, by a computer, an unsupervised Region-Growing Network (RGN) based on the input data and a selected training algorithm to generate a trained RGN, wherein the selected training algorithm includes a region-growing algorithm and a grouping loss function. In one example, the method includes, for each of a plurality of reference frames within the video frame sequence, computing a bidirectional optical flow sequence between the reference frame and any neighboring frame of the reference frame within the video frame sequence. According to certain examples, the method includes generating pixel-level masks for any moving object identified within the video frame sequence. In at least one example, the method includes applying the region-growing algorithm to generate a coarse mask for each moving object from the pixel-level masks generated for any moving object identified within the video frame sequence. According to such examples, the method includes applying the grouping loss function to the coarse mask generated for each moving object to generate refined masks consistent across consecutive frames of the video frame sequence corresponding to each coarse mask. In one example, the method includes outputting, using the trained RGN, the refined masks as object segmentation data for the video data received.

In at least one example, a system includes processing circuitry, non-transitory computer-readable media. According to certain examples, the system includes instructions that configure the processing circuitry to obtain input data including video data degraded by atmospheric turbulence. In at least one example, the system includes instructions that configure the processing circuitry to extract a video frame sequence from the video data. According to such examples, the system includes instructions that configure the processing circuitry to train, by a computer, an unsupervised Region-Growing Network (RGN) based on the input data and a selected training algorithm to generate a trained RGN, wherein the selected training algorithm includes a region-growing algorithm and a grouping loss function. In one example, the system includes instructions that configure the processing circuitry to compute, for each of a plurality of reference frames within the video frame sequence, a bidirectional optical flow sequence between the reference frame and any neighboring frame of the reference frame within the video frame sequence. According to certain examples, the system includes instructions that configure the processing circuitry to generate pixel-level masks for any moving object identified within the video frame sequence. In at least one example, the system includes instructions that configure the processing circuitry to apply the region-growing algorithm to generate a coarse mask for each moving object from the pixel-level masks generated for any moving object identified within the video frame sequence. According to such examples, the system includes instructions that configure the processing circuitry to apply the grouping loss function to the coarse mask generated for each moving object to generate refined masks consistent across consecutive frames of the video frame sequence corresponding to each coarse mask. In one example, the system includes instructions that configure the processing circuitry to output, using the trained RGN, the refined masks as object segmentation data for the video data received.

In one example, there is non-transitory computer-readable media, and instructions that, when executed by the processing circuitry, configure the processing circuitry to perform various tasks. According to certain examples, the system includes instructions that configure the processing circuitry to obtain input data including video data degraded by atmospheric turbulence. In at least one example, the system includes instructions that configure the processing circuitry to extract a video frame sequence from the video data. According to such examples, the system includes instructions that configure the processing circuitry to train, by a computer, an unsupervised Region-Growing Network (RGN) based on the input data and a selected training algorithm to generate a trained RGN, wherein the selected training algorithm includes a region-growing algorithm and a grouping loss function. In one example, the system includes instructions that configure the processing circuitry to compute, for each of a plurality of reference frames within the video frame sequence, a bidirectional optical flow sequence between the reference frame and any neighboring frame of the reference frame within the video frame sequence. According to certain examples, the system includes instructions that configure the processing circuitry to generate pixel-level masks for any moving object identified within the video frame sequence. In at least one example, the system includes instructions that configure the processing circuitry to apply the region-growing algorithm to generate a coarse mask for each moving object from the pixel-level masks generated for any moving object identified within the video frame sequence. According to such examples, the system includes instructions that configure the processing circuitry to apply the grouping loss function to the coarse mask generated for each moving object to generate refined masks consistent across consecutive frames of the video frame sequence corresponding to each coarse mask. In one example, the system includes instructions that configure the processing circuitry to output, using the trained RGN, the refined masks as object segmentation data for the video data received.

In one example, a device includes means for obtaining input data including video data degraded by atmospheric turbulence. According to certain examples, the device includes means for extracting a video frame sequence from the video data. In at least one example, the device includes means for training, by a computer, an unsupervised Region-Growing Network (RGN) based on the input data and a selected training algorithm to generate a trained RGN, wherein the selected training algorithm includes a region-growing algorithm and a grouping loss function. According to such examples, the device includes means for computing, for each of a plurality of reference frames within the video frame sequence, a bidirectional optical flow sequence between the reference frame and any neighboring frame of the reference frame within the video frame sequence. In one example, the device includes means for generating pixel-level masks for any moving object identified within the video frame sequence. According to certain examples, the device includes means for applying the region-growing algorithm to generate a coarse mask for each moving object from the pixel-level masks generated for any moving object identified within the video frame sequence. In at least one example, the device includes means for applying the grouping loss function to the coarse mask generated for each moving object to generate refined masks consistent across consecutive frames of the video frame sequence corresponding to each coarse mask. According to such examples, the device includes means for outputting, using the trained RGN, the refined masks as object segmentation data for the video data received.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of computing device, in accordance with aspects of this disclosure.

FIG. 2 depicts a technique for robustly segmenting moving objects under various turbulence strengths, in accordance with aspects of the disclosure.

FIGS. 3A and 3B depict an Unsupervised Region-Growing Network (URG-Net) pipeline, in accordance with aspects of the disclosure.

FIGS. 4A and 4B depict a pipeline having an epipolar geometry-based motion disentanglement process, in accordance with aspects of the disclosure.

FIG. 5 depicts step-by-step intermediate results for motion feature map estimation, in accordance with aspects of the disclosure.

FIG. 6 depicts a pipeline for region growing-based segmentation, in accordance with aspects of the disclosure.

FIG. 7 illustrates Table 1, which provides a comparison of existing datasets on turbulent images or videos, in accordance with aspects of the disclosure.

FIG. 8 illustrates Table 2, which provides qualitative comparisons with state-of-the-art unsupervised moving object segmentation techniques on a DOST dataset, in accordance with aspects of the disclosure.

FIGS. 9A and 9B depicts qualitative comparisons with state-of-the-art methods on Dynamic Object Segmentation in Turbulence (DOST) with respect to various turbulence strengths, in accordance with aspects of the disclosure.

FIG. 10 depicts example results of handling videos including comparisons with camera shake, in accordance with aspects of the disclosure.

FIG. 11 depicts example results of handling videos including comparisons with turbulence strength, in accordance with aspects of the disclosure.

FIG. 12 illustrates Table 3, which provides results of ablation studies for different variants of the network as applied by a region growing segmentation framework, in accordance with aspects of the disclosure.

FIG. 13 illustrates Table 4, which provides results of ablation studies for different intervals, in accordance with aspects of the disclosure.

FIG. 14 illustrates Algorithm 1, which provides example operations for Region Growing Segmentation (RGS), in accordance with aspects of the disclosure.

FIG. 15 is a flow diagram illustrating an example method for implementing an unsupervised region-growing network for use with object segmentation in atmospheric turbulence, in accordance with one or more techniques of this disclosure.

Like reference characters denote like elements throughout the text and figures.

### DETAILED DESCRIPTION

Aspects of the disclosure provide improved methodologies to address the challenge of providing object segmentation in the presence of atmospheric turbulence. Utilizing a two-stage unsupervised foreground object segmentation network configured for dynamic scenes affected by atmospheric turbulence, the disclosed methodologies enable the effective and systematic detection and separation of multiple objects within a subject video data source even when severe turbulence conditions are present at the time and place of video capture.

In some examples, processing circuitry receives as input, video data captured in the presence of atmospheric turbulence. Averaged optical flow from turbulence-distorted image sequences are identified and utilized to feed a region-growing algorithm implemented by a Region Growing Segmentation (RGS) network. The RGS network generates as output preliminary coarse masks for each moving object in the video. Processing circuitry further utilizes a U-Net architecture configured to compute consistency and grouping losses to refine these the preliminary coarse masks into refined masks by optimizing their spatio-temporal alignment. Experimental results demonstrate the superiority of the described techniques over prior approaches in terms of both superior predictive performance as well as negating any requirement for labeled training across varied turbulence strengths for long-range video.

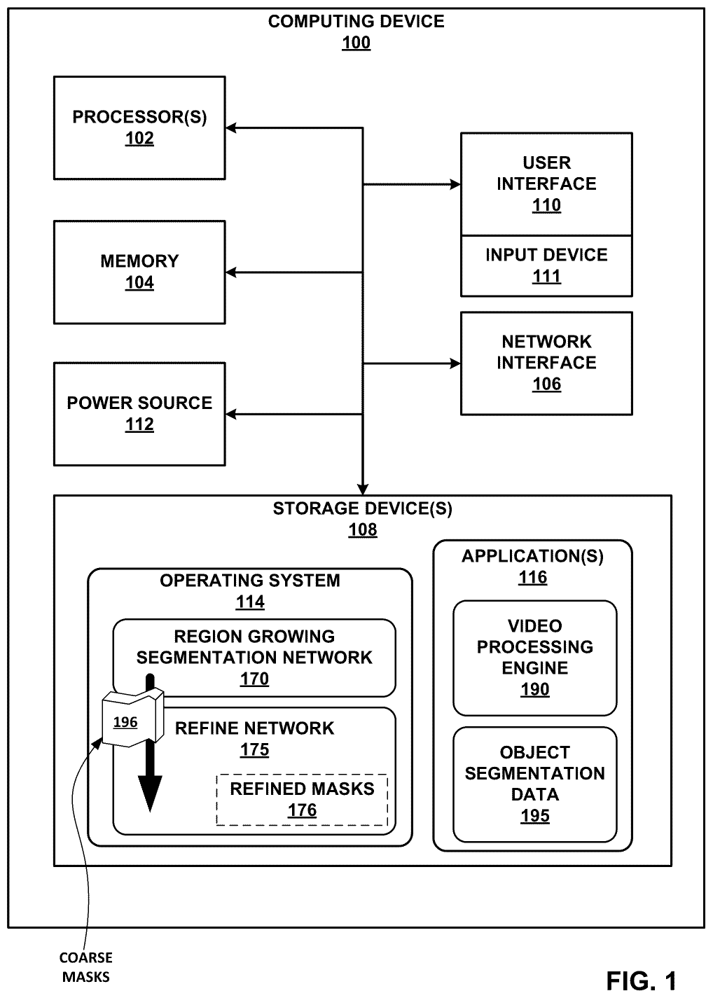

FIG. 1 is a block diagram illustrating further details of one example of computing device, in accordance with aspects of this disclosure. FIG. 1 illustrates only one particular example of computing device 100. Many other example embodiments of computing device 100 may be used in other instances.

As shown in the specific example of FIG. 1, computing device 100 may include one or more processors 105, memory 104, a network interface 106, one or more storage devices 108, user interface 110, and power source 112. Computing device 100 may also include an operating system 114. Computing device 100, in one example, may further include one or more applications 116, such as video processing engine 190 and may provide as output, object segmentation data 195. Video processing engine 190 may utilize a two-stage unsupervised foreground object segmentation network tailored for dynamic scenes affected by atmospheric turbulence uncertainty to generate object segmentation data 195 as output.

Operating system 114 may execute various functions including region growing segmentation network 170 which is utilized to generate coarse masks 196 from video input data and refine network 175 which is utilized to receive as input coarse masks 196 from region growing segmentation network 170 generate refined masks 176 as output. One or more other applications 116 may also be executable by computing device 100. Components of computing device 100 may be interconnected (physically, communicatively, and/or operatively) for inter-component communications.

In some examples, processing circuitry including one or more processors 105, implements functionality and/or process instructions for execution within computing device 100. For example, one or more processors 105 may be capable of processing instructions stored in memory 104 and/or instructions stored on one or more storage devices 108.

Memory 104, in one example, may store information within computing device 100 during operation. Memory 104, in some examples, may represent a computer-readable storage medium. In some examples, memory 104 may be a temporary memory, meaning that a primary purpose of memory 104 may not be long-term storage. Memory 104, in some examples, may be described as a volatile memory, meaning that memory 104 may not maintain stored contents when computing device 100 is turned off. Examples of volatile memories may include random access memories (RAM), dynamic random-access memories (DRAM), static random-access memories (SRAM), and other forms of volatile memories. In some examples, memory 104 may be used to store program instructions for execution by one or more processors 105. Memory 104, in one example, may be used by software or applications running on computing device 100 (e.g., one or more applications 116) to temporarily store data and/or instructions during program execution.

One or more storage devices 108, in some examples, may also include one or more computer-readable storage media. One or more storage devices 108 may be configured to store larger amounts of information than memory 104. One or more storage devices 108 may further be configured for long-term storage of information. In some examples, one or more storage devices 108 may include non-volatile storage elements. Examples of such non-volatile storage elements may include magnetic hard disks, optical discs, floppy disks, Flash memories, or forms of electrically programmable memories (EPROM) or electrically erasable and programmable (EEPROM) memories.

Computing device 100, in some examples, may also include a network interface 106. Computing device 100, in such examples, may use network interface 106 to communicate with external devices via one or more networks, such as one or more wired or wireless networks. Network interface 106 may be a network interface card, such as an Ethernet card, an optical transceiver, a radio frequency transceiver, a cellular transceiver or cellular radio, or any other type of device that can send and receive information. Other examples of such network interfaces may include BLUETOOTH®, 3G, 4G, 1G, LTE, and WI-FI® radios in mobile computing devices as well as USB. In some examples, computing device 100 may use network interface 106 to wirelessly communicate with an external device such as a server, mobile phone, or other networked computing device.

Computing device 100 may also include user interface 110. User interface 110 may include one or more input devices 111, such as a touch-sensitive display. Input device 111, in some examples, may be configured to receive input from a user through tactile, electromagnetic, audio, and/or video feedback. Examples of input device 111 may include a touch-sensitive display, mouse, keyboard, voice responsive system, video camera, microphone or any other type of device for detecting gestures by a user. In some examples, a touch-sensitive display may include a presence-sensitive screen.

User interface 110 may also include one or more output devices, such as a display screen of a computing device or a touch-sensitive display, including a touch-sensitive display of a mobile computing device. One or more output devices, in some examples, may be configured to provide output to a user using tactile, audio, or video stimuli. One or more output devices, in one example, may include a display, sound card, a video graphics adapter card, or any other type of device for converting a signal into an appropriate form understandable to humans or machines. Additional examples of one or more output devices may include a speaker, a cathode ray tube (CRT) monitor, a liquid crystal display (LCD), or any other type of device that can generate intelligible output to a user.

Computing device 100, in some examples, may include power source 112, which may be rechargeable and provide power to computing device 100. Power source 112, in some examples, may be a battery made from nickel-cadmium, lithium-ion, or other suitable material.

Examples of computing device 100 may include operating system 114. Operating system 114 may be stored in one or more storage devices 108 and may control the operation of components of computing device 100. For example, operating system 114 may facilitate the interaction of one or more applications 116 with hardware components of computing device 100.

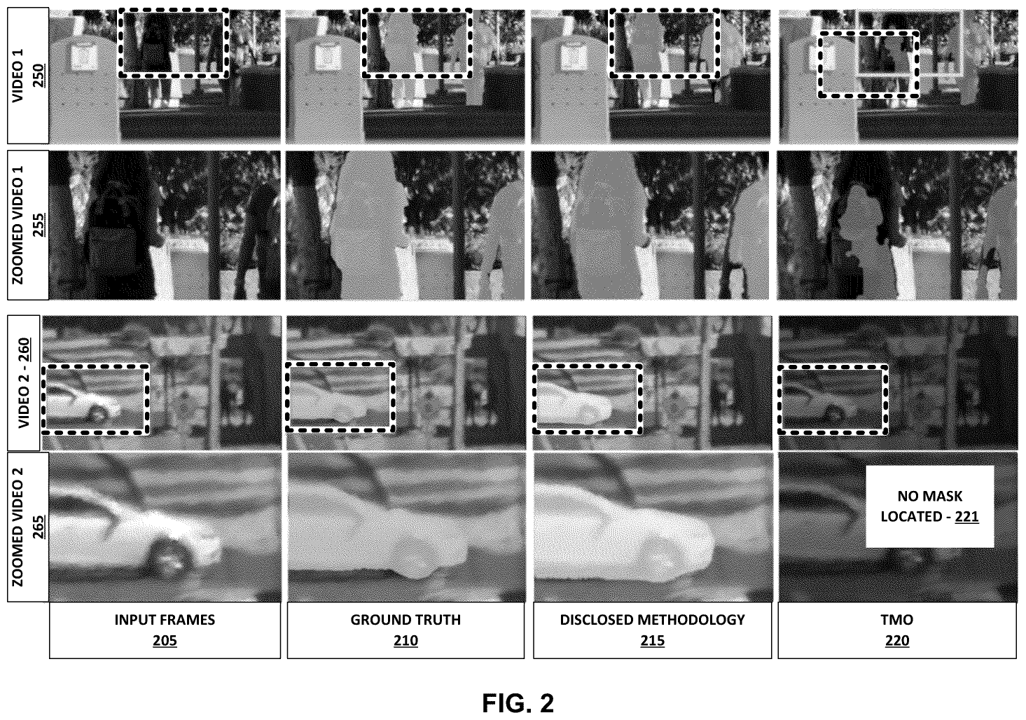

FIG. 2 depicts a technique for robustly segmenting moving objects under various turbulence strengths, in accordance with aspects of the disclosure. In particular, video 1 250 and video 1 zoomed 255 depicts application of region growing segmentation framework 170, while video 2 260 and video 2 265 depicts how state-of-the-art techniques may fail under strong turbulence. The leftmost column depicts input frames 205, the second column depicts ground truth 210 information, the third column depicts application of disclosed methodology 215, and the last column depicts TMO 220 (e.g., Treating Motion as Option to Reduce Motion Dependency in Unsupervised Video Object Segmentation) which results in no mask located 221.

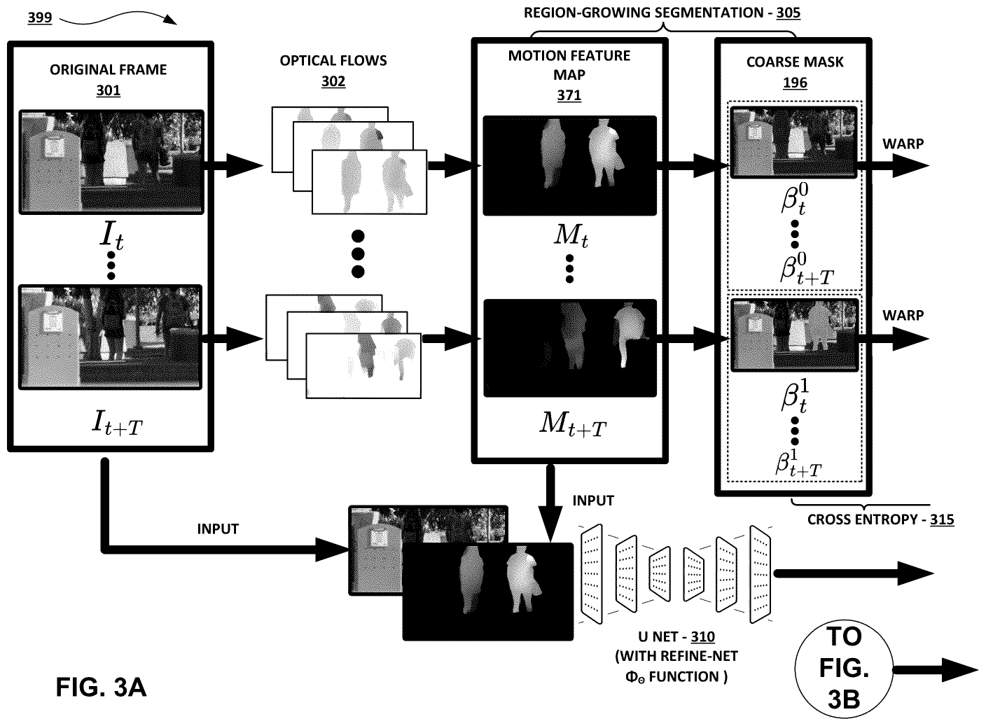

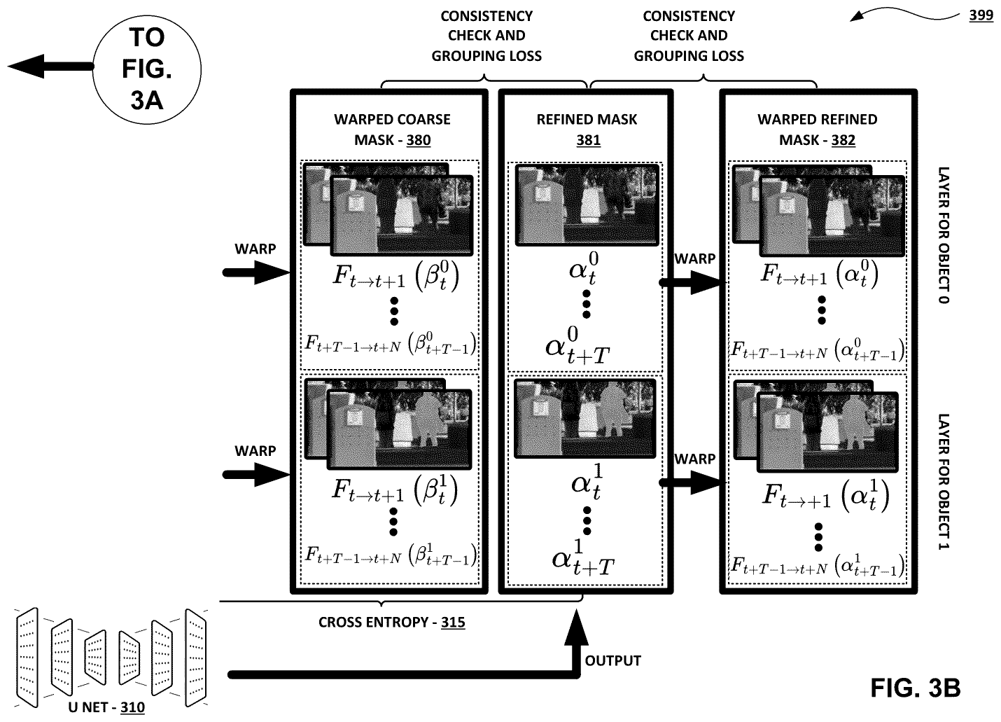

Atmospheric turbulence poses great challenges to traditional segmentation techniques. The described methodology overcomes these challenges through the use of a two-stage unsupervised moving segmentation algorithm specially designed for dynamic scenes affected by atmospheric turbulence (refer to FIGS. 3A-3B).

Operating on the accepted principle that rigid motion and turbulence have differing temporal cues, the described methodology leverages these differing temporal cues to maintain the spatial relationship and structure consistency of moving objects among different frames. The described methodology generates optimized and robust optical flow feature maps which are resilient to the effects of turbulence and which in turn are used to produce initial coarse masks for each object in every frame. A refinement network improves mask accuracy further by increasing spatiotemporal consistency of the coarse masks.

FIGS. 3A and 3B depict an Unsupervised Region-Growing Network (URG-Net) 399 pipeline, in accordance with aspects of the disclosure. The depicted network and URG-Net pipeline consists of both (1) Region Growing Segmentation (RGS) function 305 and (2) Refine-Net Φ_{θ} function 310. The RGS function 305 effectively segments different moving objects in a subject video, even when affected by atmospheric turbulence. The unsupervised Φ_{θ} network 310 further improves segmentation accuracy.

Original frame 301 is provided as input into Refine-Net Φ_{θ} function 310. Additionally, optical flows 302 are extracted from original frame 301 and provided into region-growing segmentation 305 function which provides motion feature map 371 and then coarse mask 196 which is then warped. Motion feature map 371 is also provided as input into Refine-Net Φ_{θ} function 310. Cross entropy and Refine-Net Φ_{θ} function 310 are depicted as advancing to FIG. 3B. At FIG. 3B, warped coarse masks 380 and refined mask 381 are provided as a continuation of the cross entropy 315 function from FIG. 3A, with Refine-Net Φ_{θ} function 310 providing the output resulting in refined mask 381. Each of warped coarse masks 380 and refined mask 381 are subjected to consistency checks and grouping loss. Another warp function occurs providing warped refined mask 382 with refined mask 381 and warped refined mask 382 again being subjected to consistency checks and grouping loss.

In the example of FIGS. 3A-3B, the disclosed algorithm and methodology structure provides at least the following contributions:

In particular, region growing segmentation framework 170 applies a two-stage unsupervised moving object segmentation network that is resilient to degradations caused by atmospheric turbulence. The disclosed methodology introduces a region-growing algorithm that distinguishes between object motion and turbulence motion by analyzing the motion patterns. The disclosed methodology also provides a bidirectional spatio-temporal consistency check for fine-grain mask refinement.

Experimental results are provided using the disclosed methodology operating on a real-world video dataset with turbulent scenes. The experimental dataset contains a variety of scenes captured with various camera settings. The experimental dataset also provides ground-truth segmentation masks which are used as the benchmark for evaluating turbulence-resilient algorithms.

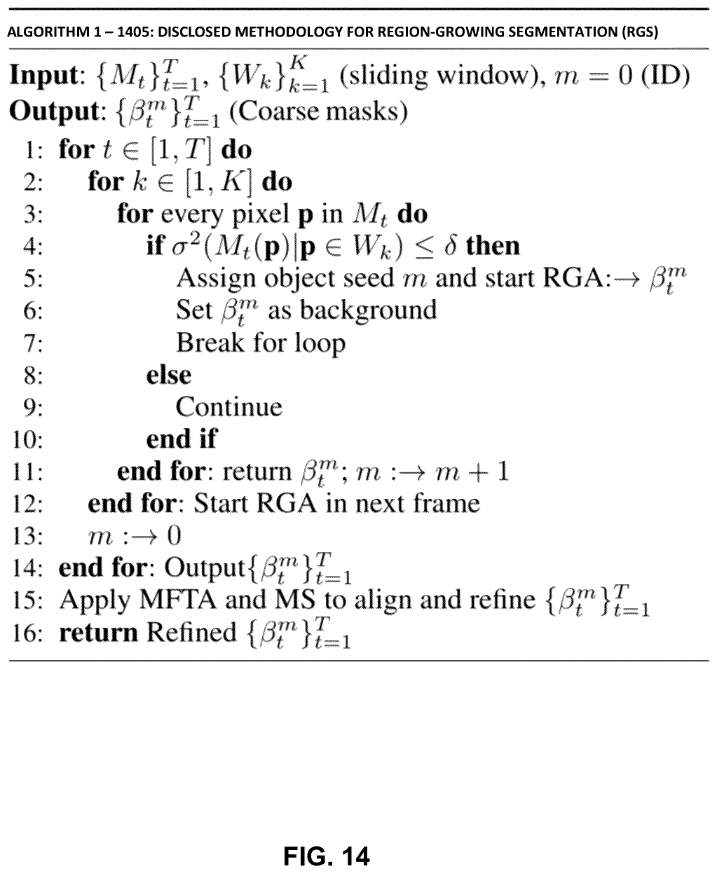

Experimental results further provide an evaluation of Algorithm 1, as set forth at FIG. 14, element 1405, against the real-world data set. By comparing the disclosed methodology with recent state-of-the-art techniques, Algorithm 1 at element 1405 is demonstrated against real-world data as being both accurate and robust in segmenting various moving objects, even in the presence of atmospheric turbulence.

Prior known methodologies for unsupervised object segmentation in general were surveyed as well as specific segmentation techniques for imaging through turbulence, and no prior known technique adequately solves the problem of object segmentation in the presence of varying atmospheric turbulence as addressed by the disclosed methodologies described herein.

Unsupervised Object Segmentation for video: Contrasted with supervised segmentation algorithms the disclosed methodologies utilize unsupervised techniques. More particularly, unsupervised video object segmentation has largely revolved around exploiting optical flow and feature alignment. Motion information, derived via optical flow, has been a cornerstone for distinguishing dynamic foregrounds from static or semi-static backgrounds, often precomputed using models such as RAFT, PWC-Net, and FLow-Net. Prior attempts utilized a network which fused optical flow with hierarchical feature alignment for object segmentation. For instance, AMC-Net utilizes a dual encoder-based co-attention mechanism for a balanced fusion of appearance and motion features. In the same vein, TransportNet introduces structural matching to align input frames and optical flow, suppressing distracting signals. Another prior approach operates by correlating spatial and temporal domains to pinpoint and segment salient objects. Other methods also exploit optical flow to emphasize the foreground and guide the segmentation process contributing to enhanced segmentation performance and boundary localization. One method operates by “treating motion as an option” (also called “TMO”) and reduces optical flow dependency, thus focusing more on feature alignment and fusion. In yet another approach, optical flow is utilized for generating prototype memories for feature alignment, thus reducing temporal inconsistency and enhancing segmentation accuracy.

Region growing segmentation framework 170 differs from all prior known methods as it utilizes an averaged optical flow and other techniques to counteract the detrimental impact of turbulence on rigid moving objects. Furthermore, region growing segmentation framework 170 employs a two-stage network to further enhance provided outcomes. Several prior techniques have aimed to avoid dependence on motion cues or optical flow. For instance, one technique uses a zero-shot approach that utilizes graph-based methods to model frame relationships in videos. In such a technique, an unsupervised method was utilized to establish dense correspondences between pixel embeddings of reference and current frames. Another approach utilized prioritized mask quality and propagation through an online unsupervised method for video segmentation. However, atmospheric turbulence can blur the border between the background and foreground in an RGB input image, posing a challenge for segmentation without the use of optical flow, and thus, fails to adequately address the problem of object segmentation in the presence of varying atmospheric turbulence.

Turbulence-specific object segmentation algorithms: Adapting video object segmentation to varying atmospheric conditions presents unique challenges and opportunities. One prior known technique addressed the problem of accurate semantic segmentation in atmospheric turbulence conditions. In particular, the physical imaging mechanism in turbulence conditions and construct turbulence-degraded image datasets for training was investigated. Additionally, the proposed Boundary-aware DeepLabv3+ network incorporates edge-aware loss and a border auxiliary supervision module to improve boundary segmentation. However, these techniques are supervised in nature, require training data, and do not adequately generalize to unseen turbulent environments.

In contrast, the disclosed methodology for unsupervised object segmentation in the presence of varying atmospheric turbulence very specifically does not require training data.

Geometric Constraints for Motion Analysis: Geometric constraints have been examined to enhance the understanding of spatial information, including depth estimation, pose estimation, camera calibration, and 3D reconstruction. These constraints also contribute to motion analysis. A variational model has been introduced to estimate optical flow along with the fundamental matrix. A fundamental matrix has also been applied as a weak constraint to guide optical flow estimation. Another approach reformulates the optical flow estimation problem into a one-dimensional search problem by employing precomputed fundamental matrices under small motion assumptions. Semantic information has been incorporated to distinguish dynamic objects from static backgrounds, with strong geometric constraints applied to the static regions. Additionally, global geometric constraints have been integrated into network learning for unsupervised optical flow estimation. Use of the Sampson error, which quantifies the consistency of epipolar geometry, may also be utilized to develop a loss function for layer decomposition in videos.

Region growing segmentation framework 170 may utilize such techniques to implement a geometry-based consistency check to distinguish rigid motion from other types of motion, such as turbulent motion and camera-induced motion. In such an example, Sampson distance may be used to evaluate geometric consistency between adjacent video frames.

Turbulent Image and Video Restoration and Segmentation: Analyzing images or videos affected by air turbulence presents a significant challenge in computer vision due to distortions and blurring effects. Most existing methods have concentrated on image and video restoration. Early physics-based approaches explored turbulence modeling, such as the Kolmogorov model, and applied inversion techniques to restore clear images. One category of methods employs “lucky patches” to mitigate turbulence-induced artifacts, although these techniques generally assume static scenes. Motion cues, such as optical flow, have also been leveraged for turbulent image restoration. Another approach introduces an optical-flow-guided lucky patch technique to restore images of dynamic scenes.

Region growing segmentation framework 170 builds integrates recent advancements using neural networks to perform turbulence restoration. For example, region growing segmentation framework 170 may apply a physics-inspired transformer model for restoration. An unsupervised network may help to compensate for turbulence effects using deformable grids, which have been further extended by region growing segmentation framework 170 to address more realistic turbulence distortions.

Region growing segmentation framework 170 also provides object segmentation under atmospheric turbulence, an area which remains relatively unexplored. For instance, region growing segmentation framework 170 may apply a supervised network for semantic segmentation under turbulent conditions, generating a physically realistic simulated training dataset. Prior techniques struggle with scene motion and real-world domain generalization. Such prior known techniques may apply an optical flow-based segmentation method as part of a turbulent video restoration pipeline. Unlike these approaches, region growing segmentation framework 170 segments moving objects directly without first restoring or enhancing the turbulent video. By taking this approach, segmentation masks remain consistent with the actual turbulent video rather than being influenced by restoration artifacts.

### Unsupervised Moving Object Segmentation:

Algorithm Overview: For a given turbulent video consisting of frames denoted as {Iₜ|t=1, 2, . . . , T}, where T represents the total number of frames and Iₜ corresponds to an individual frame, the first step involves computing bidirectional optical flow: [symbol] ₜ={F_{t→t±i}|i=1, . . . , B}. Here, B represents the maximum number of frames considered for calculation, F_{t→t+i} denotes forward flow, and F_{t→t-i} represents backward flow.

An epipolar geometry-based consistency check is then applied to separate rigid object motion from turbulence-induced and camera-induced motions. This process results in the generation of per-frame motion feature maps {Mₜ|t=1, 2, . . . , T}, which highlight candidate motion regions.

Following this, a detect-then-grow strategy, referred to as “region growing,” is used to produce motion segmentation masks {βₜ^{m}|t=1, 2, . . . , T} for each moving object. These masks are derived from a small set of seedling pixels selected from the motion feature maps.

For every moving object m, from a small set of seedling pixels selected from {Mₜ}ₜ₌₁^{T}. The segmentation masks are further refined using a U-Net model trained with bidirectional spatial-temporal consistency losses and pixel grouping loss. The final output consists of per-frame, per-object binary masks {αₜ^{m}|t=1, 2, . . . , T}, which accurately segment each moving object within the dynamic scene.

According to at least one embodiment, region growing segmentation framework 170 accepts two primary inputs: the video frame sequence, degraded by atmospheric turbulence, and the bidirectional optical flow sequences computed between each reference frame and its neighboring frames. In such an example, the frame sequence is denoted as {Iₜ|t=1,2, . . . , T}, with T representing the total number of frames. The forward flow and backward flow sequences are denoted as [symbol] ₜ={F_{t→t±i}|i=0,1, . . . , B}. The Unsupervised Region Growing Network (URG-Net) may operate in two stages, aiming to produce pixel-level masks {αₜ^{m}|t=1, 2, . . . , T}∈ [symbol] ^{H×W} for every moving object m within a given video. The first stage employs a region-growing algorithm, using optical flow sequences { [symbol] ₜ}ₜ₌₁^{T}, and generates coarse masks {βₜ^{m}|t=1, 2, . . . , T}∈ [symbol] ^{H×W}. In the second stage, each Iₜ is concatenated with its corresponding feature map Mₜ, generated by the region growing methods. This combined tensor feeds into the Refine-Net to refine {βₜ^{m}}ₜ₌₁^{T}, enhancing the initial masks {βₜ^{m}}ₜ₌₁^{T} through the unique bidirectional spatial-temporal consistency loss and pixel grouping loss. Integrating spatial data from frames with temporal insights from optical flow, URG-Net robustly segments diverse moving objects, even when the video input is distorted by atmospheric turbulence.

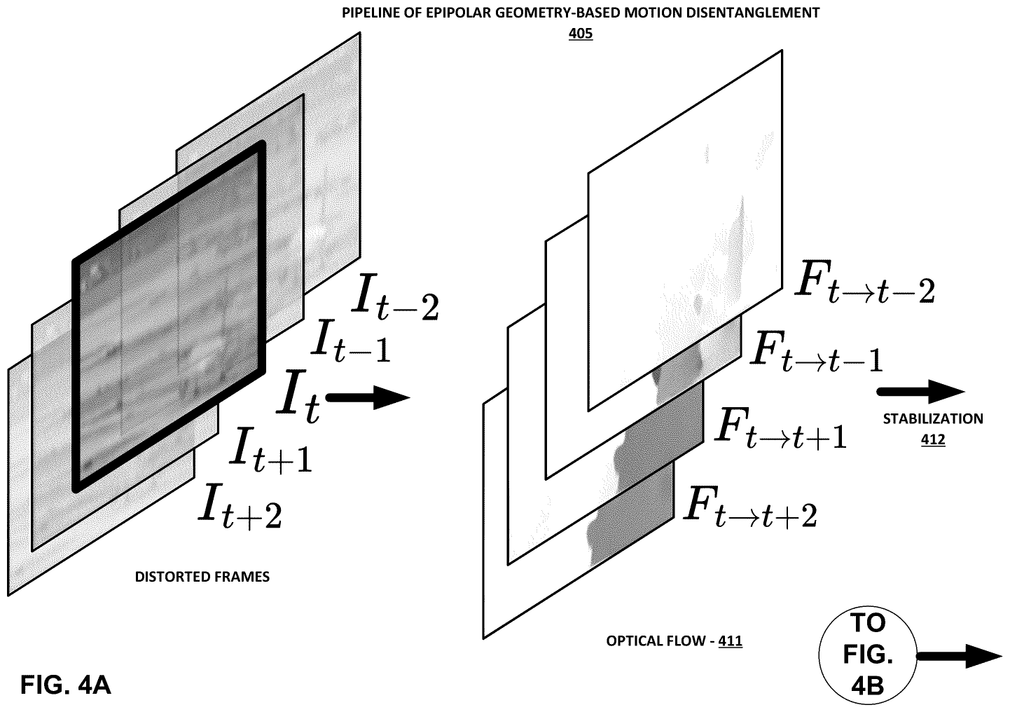

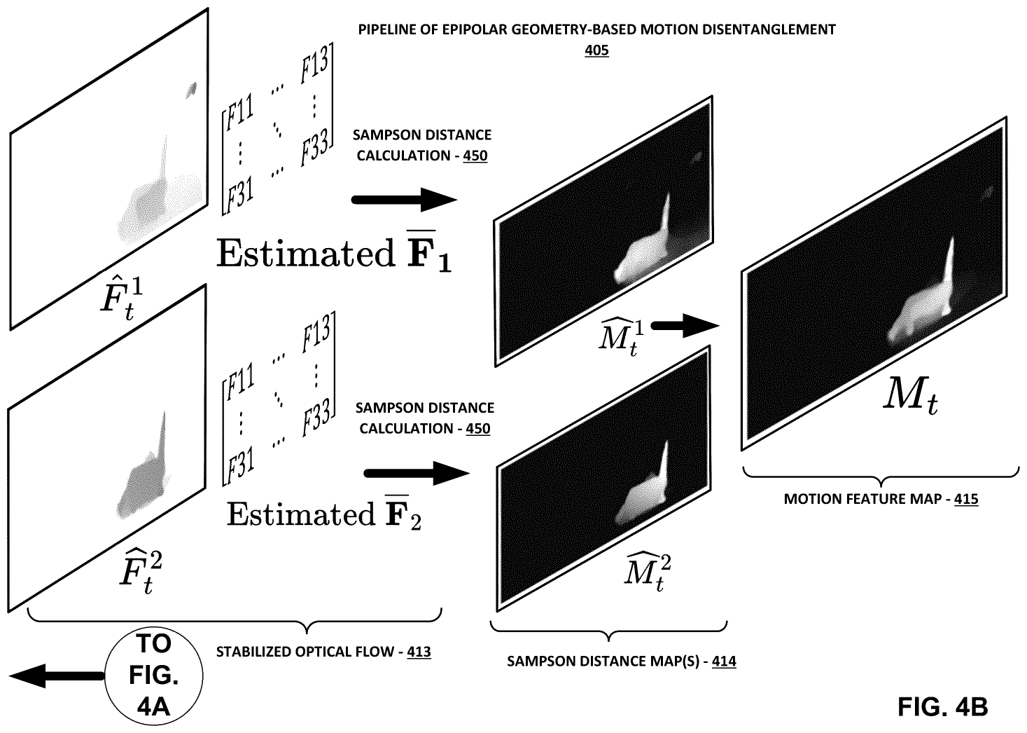

FIGS. 4A and 4B depict a pipeline having an epipolar geometry-based motion disentanglement 405, in accordance with aspects of the disclosure. As depicted, region growing segmentation framework 170 may apply a geometry-based consistency check to generate motion feature maps that only preserve object motion due to the raw optical flows being downgraded by turbulence.

Epipolar geometry-based motion disentanglement is a technique used in computer vision to separate object motion from camera motion utilizing epipolar constraints. Epipolar geometry-based motion disentanglement leverages the fundamental relationship between two views of a scene, using corresponding points and the epipolar constraint to estimate depth and motion independently. By analyzing pixel correspondences across frames, epipolar geometry-based motion disentanglement distinguishes between global camera-induced motion and independent object motion, improving tasks like video object segmentation and 3D reconstruction. Epipolar geometry-based motion disentanglement may be applied within unsupervised learning scenarios, where explicit supervision is unavailable, using motion cues extracted from video data. Epipolar geometry-based motion disentanglement may improve robustness in dynamic scenes by reducing reliance on motion consistency.

Epipolar Geometry-Based Motion Disentanglement: One challenge of motion disentanglement arises due to turbulence perturbation in rigid motion analysis. To address this issue, region growing segmentation framework 170 verifies rigid geometric consistency across video frames. Pixels corresponding to moving objects do not adhere to the geometric consistency constraint imposed by the image formation model.

To enhance spatial-temporal consistency among video frames, Sampson distance calculation 450 may be determined as a measure of geometric consistency within a given epipolar geometry. Stabilization 412 is initially applied to optical flow 411 between adjacent frames, in which the adjacent frames are averaged to stabilize direct estimations { [symbol] }, as these estimations are highly susceptible to turbulence perturbation. The next step involves computing the Sampson distance using fundamental matrices derived from the averaged optical flow to provide stabilized optical flow 413.

Resulting Sampson distance maps 414 are then merged to form motion feature maps 415, denoted as {Mₜ|t=1, 2, . . . , T}. The values in these motion feature maps serve as indicators of rigid motion likelihood, where higher values suggest a greater probability of rigid motion. The complete pipeline for epipolar geometry-based motion disentanglement is illustrated in FIGS. 4A and 4B.

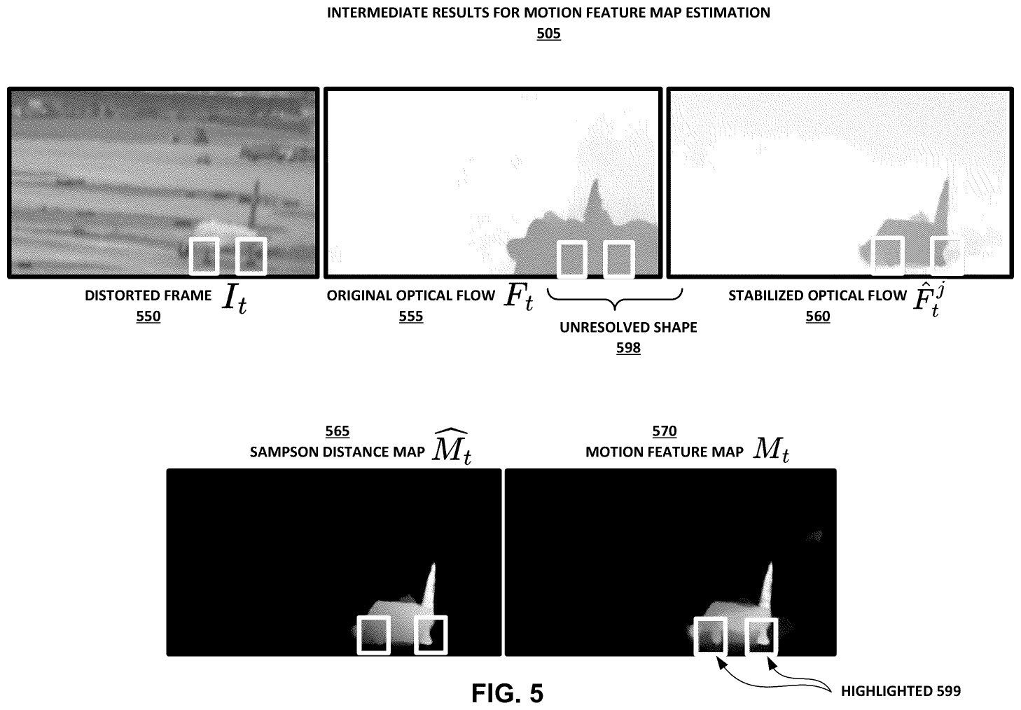

FIG. 5 depicts step-by-step intermediate results for motion feature map estimation 505, in accordance with aspects of the disclosure. In particular, intermediate results for motion feature map estimation 505 includes distorted frame 550, original optical flow 555, stabilized optical flow 560, Sampson distance map 565, and motion feature map 570.

Optical Flow Stabilization: Atmospheric turbulence introduces erratic pixel shifts in video frames, leading to errors in optical flow estimation. To mitigate this issue, region growing segmentation framework 170 may stabilize optical flow estimations by assuming consistent object motion over short time intervals. Optical flow is then averaged within a small time-step (e.g., a configurable time-step or a time-step below a threshold) to reduce errors caused by turbulence perturbation while preserving features of actual rigid motion.

Given a sequence of bidirectional optical flow [symbol] ₜ={F_{t→t±i}}ᵢ₌₀^{B}, a sequence of per-frame stabilized flow [symbol] ₜ={\hat{F}ₜ^{j}|j=1, 2, . . . , A} is computed, where A represents the total number of stabilized flows for each frame. The stabilized optical flow 560 is obtained by averaging the original optical flow 555 sequence within a short interval, as defined in Equation 1, set forth below, as follows:

$${\hat{F}}_{t}^{j} = \frac{1}{\vert {𝒦}^{j} \vert} {\sum }_{i ∈ {𝒦}^{j}} \frac{{F}_{t \to t + i}}{i} ,$$

where [symbol] ^{j} is the temporal interval used for calculating \hat{F}ₜ^{j}, namely the subset of {x|x∈ [symbol] , −B≤x≤B}.

Geometric Consistency Check: The primary assumption is that pixels corresponding to moving objects exhibit larger geometric consistency errors compared to the static background when mapping a frame to its neighboring time frame using a fundamental matrix. Sampson distance map 565 quantifies rigid geometric consistency by measuring the distance between a pair of video frames under the constraint of epipolar geometry.

Since moving objects do not conform to epipolar geometry, which assumes a static scene, their correspondences produce large Sampson distances. Although turbulence perturbation also disrupts epipolar geometry, the errors introduced are significantly smaller and more random, making them easily removable through averaging.

Given a stabilized optical flow \hat{F}ₜ^{j}, the corresponding Sampson distance map \hat{M}ₜ^{j} is computed according to Equation 2, set forth below, as follows:

$${\hat{M}}_{t}^{j} ( {p}_{1} , {p}_{2} ) = \frac{{( {p}_{2}^{⊤} \overline{F} {p}_{1} )}^{2}}{{( \overline{F} {p}_{1} )}_{1}^{2} + {( \overline{F} {p}_{1} )}_{2}^{2} + {( {\overline{F}}^{⊤} {p}_{2} )}_{1}^{2} + {( {\overline{F}}^{⊤} {p}_{2} )}_{2}^{2}} ,$$

where p₁ and p₂ represent the homogeneous coordinates of a pair of corresponding points in two neighboring frames. Correspondences are determined using stabilized optical flow, where p₂=p₁+\hat{F}ₜ^{j}(p₁). The fundamental matrix F̅ between the two frames may be estimated using Least Median of Squares (LMedS) regression.

To refine motion estimation, all available Sampson distance maps 565 denoted as {\hat{M}ₜ^{j}|j=1, 2, . . . , A}, for a given frame, Iₜ are averaged to produce the per-frame motion feature map 570, denoted as

$${M}_{t} = \frac{1}{A} {\sum }_{j = 1}^{A} {\hat{M}}_{t}^{j} .$$

Motion feature map 570 represents the likelihood of a pixel belonging to a moving object.

As depicted by intermediate results for motion feature map estimation 505, a motion feature map 570 original optical flow map 555, which is distorted by turbulence, fails to resolve the airplane as depicted by unresolved shape 598. After stabilization and geometric consistency checks, the final motion feature map 570 successfully preserves the shape of the airplane, including its highlighted 599 wheels.

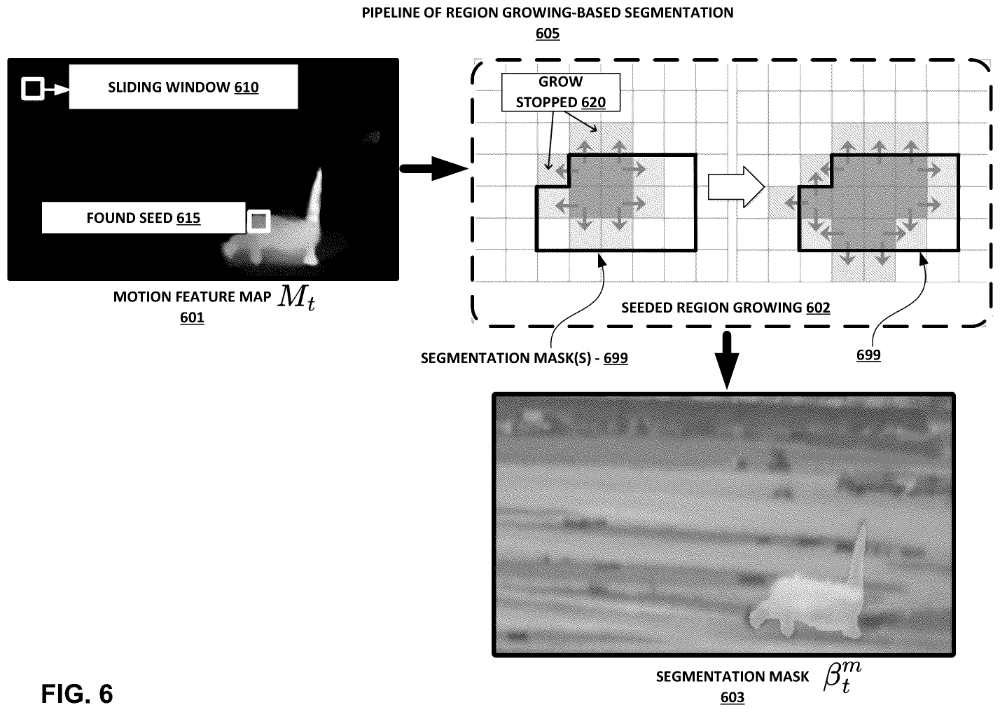

FIG. 6 depicts a pipeline for region growing-based segmentation 605, in accordance with aspects of the disclosure. As depicted, region growing segmentation framework 170 may select seeds, such as found seed 615 on the motion feature map 601 using a sliding window 610 and then grow the seeds via seeded region growing 602 to full segmentation masks 603. As depicted by FIG. 6, sliding window 610 is applied to found seed 615 within motion feature map 601. Seeded growing region 602 depicts grow stopped 620, resulting in segmentation mask 603 having the region of segmentation depicted in the lower right portion of the scene.

Region Growing-Based Segmentation: Segmentation masks for moving objects are generated using a “region growing” approach based on motion feature maps. While these motion feature maps effectively capture object motion, they remain non-binary and often exhibit fuzziness at object boundaries. For instance, according to at least one example, region growing segmentation framework 170 applies region growing segmentation to generate masks {βₜ^{m}}ₜ₌₁^{T} using optical flows { [symbol] ₜ}ₜ₌₁^{T}. Given the challenge of turbulent distortion in optical flow estimation, an averaged optical flow (AOF) may be employed, as taken from adjacent frames, to stabilize the raw sequence {Oₜ}. Region growing segmentation framework 170 may utilize the AOF to formulate motion feature map 601, denoted as Mₜ and to identify moving object seeds (e.g., dynamic seeds or a found seed 615) in each frame through sliding windows 610. Once found seed 615 is located, a region-growing method is applied to segment out nearby regions with patterns similar to the seed patch in Mₜ. The method then blinds out the searched and grown regions, finding another seed in the remaining areas of Mₜ. This process may be repeated iteratively until all pixels have been assigned to a specific motion group in each frame. To link the same object across different frame-based motion groups, a grouping method may be applied to align and filter out the outlier masks generated, thus ensuring that the same object in different frames has a consistent object seed ID and refines the aligned {βₜ^{m}}ₜ₌₁^{T}. By doing so, each object is assured to have a unique seed, thus enabling the method to distinguish among various moving objects in the video systematically and reliably.

Averaged Optical Flow (AOF): Most unsupervised moving object segmentation methods rely on optical flow. Unfortunately, performance of optical flow reliant methodologies can be significantly degraded by atmospheric turbulence. To address this problem, region growing segmentation framework 170 may utilize an averaging technique called “Averaged Optical Flow” or “AOF” to stabilize the optical flows. AOF takes the bidirectional optical flow sequence [symbol] ₜ={F_{t→t±i}}ᵢ₌₀^{B} as input, and generates an averaged flow map, according to equation 1, described above.

AOF operates on the observation that atmospheric turbulence causes erratic shifts of scene elements in videos. By assuming consistent object motion over short periods, AOF effectively refines the original optical flow, retaining key motion details and mitigating distortions from atmospheric turbulence.

Dynamic Seed Localization: Utilizing dynamic seed location, the disclosed methodology uses the magnitude of the averaged optical flow map \hat{F}ₜ to create feature map Mₜ for Iₜ, using the equation, Mₜ=normalize ∥\hat{F}ₜ(p)∥, where the term \hat{F}ₜ(p) represents the two-dimensional vector field of the related averaged optical flow. The normalization method is applied to scale the values to [0, 1]. Using the obtained Mₜ, multiple sliding windows are utilized to detect regions with moving objects, assuming similar optical flow values within such objects. A searching window Wₖ sized D×D scans Mₜ for uniform, non-zero areas.

In one example, regions are considered as dynamic seeds only if the respective region has a pixel value variation which remains below a set threshold. Specifically, for a point p within the searching window Wₖ, if the variance σ² (Mₜ(p)) is less than or equal to a small threshold δ, the region is considered uniform and seed ID is assigned. This seed then guides the region-growing algorithm to segment similar patterns in Mₜ. This procedure enables precise identification and isolation of moving objects within the frame, facilitating subsequent processing and analysis. Upon identifying a moving object, the region-growing algorithm (RGA) is then applied to the found seed 615, thus segmenting neighboring areas with similar patterns.

Initial Seed Selection: A small set of seedling pixels may be selected with high confidence of belonging to moving objects. This selection relies on the motion feature map 601, which encodes the likelihood of a pixel being in motion. Since a sliding window 610 is applied to the motion map Mₜ, the size and appearance of objects do not influence seed selection.

The sliding windows {Wₖ}ₖ₌₁^{K}, each of size D×D, scan through Mₜ to determine initial seed regions for moving objects. The value of D may be adaptively chosen based on input resolution. A found seed 615 is detected when pixels within a search window exhibit similar large values, indicating large Sampson distances in the corresponding area. Specifically, a search window Wₖ is considered to contain a valid seed when two criteria are met: First (1) its average value M̅ₜ(Wₖ) exceeds a threshold δ₁, and second (2) its variance σ²(Mₜ(Wₖ)) remains below a small threshold 82. Each selected seedling region is assigned a unique integer mask ID to differentiate multiple moving objects.

Seeded Region Growing: Segmentation masks 699 are expanded outward from the initialized seedling pixels. Each seeded region gradually extends to neighboring pixels at the boundary, following inclusion criteria defined according to Equation 3, set forth below, as follows:

$$\vert {M}_{t} ( {p}_{new} ) - {M}_{t} ( {p}_{seed} ) \vert < {δ}_{seed} ,$$

where Mₜ is the motion feature map 601 which serves as the basis for determining pixel inclusion during region growing. The pixel under consideration, denoted as p_{new}, is assessed relative to the seed pixel p_{seed} from which the region expands. The growth process is regulated by a stopping threshold, defined as δ_{seed}=0.2×Mₜ(p_{seed}).

This threshold value depends on turbulence intensity and requires adjustment for extreme cases. In conditions of stronger turbulence, a larger δ_{seed} is preferred, increasing the multiplier from 0.2 to 0.3. For weaker turbulence, the multiplier is reduced to 0.1. When turbulence is severe, object borders tend to blur, while a higher threshold restricts excessive growth, leading to more reliable segmentation.

When growing regions from multiple seeds, pixels that have already been examined are skipped to ensure that different object masks do not overlap. After RGA processing completes, a sequence of masks is obtained for each of the moving objects in the subject video, which is denoted as {βₜ^{m}}ₜ₌₁^{T}.

Mask ID Unification: In scenes containing multiple moving objects, denoted as K, the region-growing algorithm generates K segmentation masks per frame, assigning each a unique ID ranging from 1 to K. Since the region-growing process operates independently on each frame, the mask IDs may become inconsistent across frames, failing to consistently track objects. To resolve this, a K-means-based filtering technique may be applied to unify mask IDs across frames, ensuring that the same ID always corresponds to the same object.

Each mask region is represented by its centroid, defined as cₜ^{m}=mean (pₜ^{m}), where pₜ^{m} represents the coordinates of all foreground pixels within the mask. The centroids of all masks across all frames and objects are collected to optimize K K-means cluster centroids μ^{m} according to Equation 4, set forth below, as follows:

$${arg min}_{{μ}^{m}} {\sum }_{m = 1}^{K} {\sum }_{t = 1}^{T} {‖ {c}_{t}^{m} - {μ}^{m} ‖}^{2} ,$$

where K represents the total number of objects and T represents the total number of frames.

After optimization, masks are reassigned by comparing their centroids to the K-means cluster centroids. The K-means cluster IDs serve as a global reference for all frames. Each mask is assigned the ID m corresponding to the closest K-means cluster centroid:

$${m}^{*} = {arg min}_{m} ‖ {c}_{t}^{m} - {μ}^{m} ‖ .$$

Following this re-assignment, mask IDs remain consistent across all frames, ensuring that each ID uniquely identifies a specific moving object. This approach enables effective tracking of multiple moving objects throughout the scene.

Spatio-Temporal Refinement: To enhance the spatio-temporal consistency of segmentation masks, a refinement process may be applied. For example, Refine-Net Φ_{θ}, based on a U-Net backbone (refer again to U-Net pipeline 399 of FIGS. 3A-3B) may be applied by region growing segmentation framework 170 to refine the masks generated by the region-growing method.

Parameter Initialization: The video frame Iₜ is concatenated with its corresponding motion feature map Mₜ to form an input tensor, which is then processed by Refine-Net Φ_{θ}:

αₜ^{m}=Φ_{θ}(Iₜ,Mₜ)

where αₜ^{m} represents the refined mask output from Φ_{θ}. The parameters of de are initialized using the loss function defined according to Equation 5, set forth below, as follows:

$${ℒ}_{ini} = {γ}_{1} {ℒ}_{1} + {γ}_{2} {\sum }_{g} {ℒ}_{2}^{g} + {γ}_{3} {\sum }_{g} {ℒ}_{3}^{g} ,$$

where γ₁, γ₂, and γ₃ serve as balancing weights for each loss term. Training runs for 20 to 30 epochs to complete initialization.

Loss Terms: The loss function consists of three components, specifically: Pixel-wise Cross-Entropy Loss ( [symbol] ₁), bidirectional consistency loss [symbol] ₂^{g}, and another bidirectional consistency loss Lg.

Cross-Entropy Loss ( [symbol] ₁) enforces consistency between the refined output mask αₜ^{m} and the initial coarse input mask βₜ^{m}, which is computed according to Equation 6, set forth below, as follows:

$${ℒ}_{1} = \frac{1}{Ω} {\sum }_{p ∈ Ω} ( - {α}_{t}^{m} ( p ) log {α}_{t}^{m} ( p ) + {β}_{t}^{m} ( p ) log {β}_{t}^{m} ( p ) ) .$$

Bidirectional consistency loss [symbol] ₂^{g} enforces flow consistency between the refined mask α_{t+g}^{m} and the optical flow-warped input mask \hat{β}ₜ^{m}m=F_{t→t+g} (βₜ^{m}). The cross-entropy for comparison, and [symbol] ₂^{g} is written according to Equation 7, set forth below, as follows:

$${ℒ}_{2}^{g} = \frac{1}{Ω} {\sum }_{p ∈ Ω} ( - {α}_{t + g}^{m} ( p ) log {α}_{t + g}^{m} ( p ) + {\hat{β}}_{t}^{m} ( p ) log {\hat{β}}_{t}^{m} ( p ) ) .$$

Bidirectional consistency loss [symbol] ₃^{g} enforces flow consistency between α_{t+g}^{m} and the optical flow-warped version of itself, \hat{α}ₜ^{m}=F_{t→t+g}(αₜ^{m}), with [symbol] ₃^{g} written according to Equation 8, set forth below, as follows:

$${ℒ}_{3}^{g} = \frac{1}{Ω} {\sum }_{p ∈ Ω} ( - {α}_{t + g}^{m} ( p ) log {α}_{t + g}^{m} ( p ) + {\hat{α}}_{t}^{m} ( p ) log {\hat{α}}_{t}^{m} ( p ) ) .$$

After initialization, the refined mask αₜ^{m} aligns with the input mask βₜ^{m} while achieving improved temporal consistency through the two bidirectional losses.

To further enhance mask quality and consistency, an iterative refinement process constrained by a grouping function is applied. This refinement may run for 10 epochs, by way of example only, with the input reference mask βₜ^{m} updated every three epochs using a K-means-based grouping function.

For each pixel, the mask values {βₜ^{m}(p)}ₜ₌₁^{T} are concatenated with the pixel's coordinates p=(x, y) to form a tensor {Tₜ^{m}(p)}ₜ₌₁^{T}, which integrates both motion and spatial information. This combined tensor Tₜ^{m}(p) for all pixels is then used to optimize two K-means cluster centroids, θ¹, θ², where θ¹ represents the foreground cluster and θ² represents the background cluster. The centroids are optimized using function defined according to Equation 9 set forth below, as follows:

$${arg min}_{{θ}^{1} , {θ}^{2}} {\sum }_{i = 1}^{2} {\sum }_{p ∈ Ω}^{Ω} {‖ {T}_{t}^{i} - {θ}_{t}^{i} ‖}^{2} ,$$

where the domain of all pixels is denoted as Ω. The values of βₜ^{m} are re-assigned based on the proximity of Tₜ^{m}(p) to the optimized cluster centroids. If Tₜ^{m}(p) is closer to θ¹, the pixel is classified as foreground, and the mask value is set to 1. Otherwise, the pixel is classified as background, and the mask value is set to 0.

The loss function used for network optimization remains the same as in the initialization step. However, during this refinement stage, βₜ^{m} is updated every three epochs using the K-means-based grouping function. Without this grouping-based refinement, the output mask is prone to gaps and other spatial inconsistencies. While the refinement phase employs similar loss functions to the initialization, it distinguishes itself by the reference masks used in training the Refine-Net. The motivation for this refinement step is because techniques which utilize only the refine-net may sometimes lead to a misclassification within the mask, resulting in gaps or segment errors. By incorporating this grouping loss, these disparities are corrected, ensuring that nearby pixels with similar properties from the refine-net are grouped together. The refinement phase therefore results in more unified and precise segments.

This two-step refinement network enhances the original coarse masks, ensuring that they are optimized by spatial context and consistent across consecutive frames. Further application of the K-means algorithm on the refined masks yields the final, polished results.

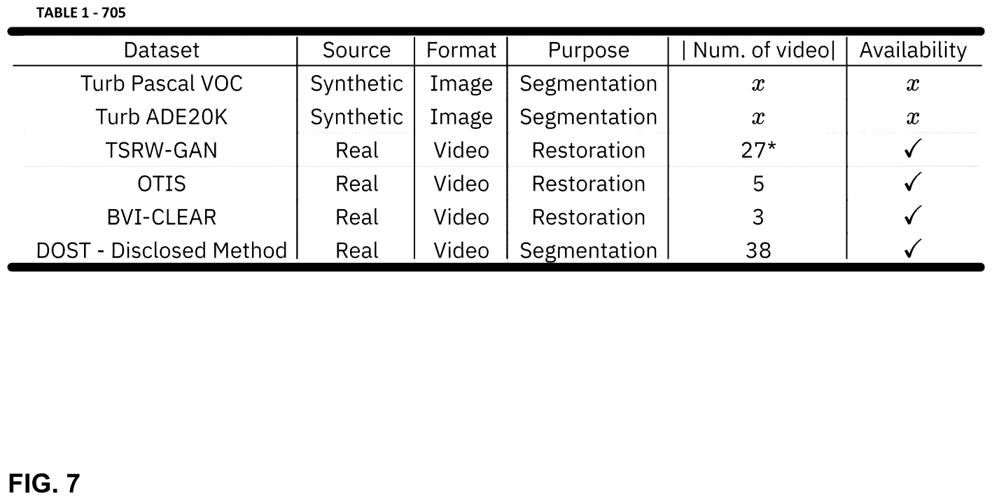

FIG. 7 illustrates Table 1 at element 705 which provides a comparison of existing datasets on turbulent images or videos, in accordance with aspects of the disclosure. The asterisks (*) indicates that the actual number of videos in TSRW-GAN is greater than 27, but many of the videos have large overlaps. The number of unique (or non-overlapped) videos is 27 as indicated by Table 1.

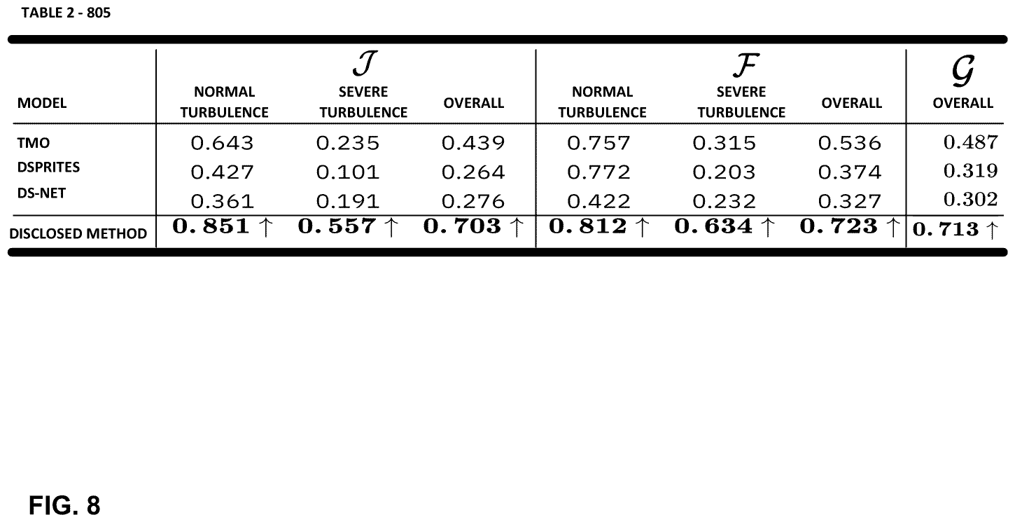

FIG. 8 illustrates Table 2 at element 805 which provides qualitative comparisons with state-of-the-art unsupervised moving object segmentation techniques on the DOST dataset, in accordance with aspects of the disclosure.

### Experiments:

DOST Dataset: A long-range turbulent video dataset, referred to as Dynamic Object Segmentation in Turbulence (DOST), was created to evaluate the described method as applied by region growing segmentation framework 170. DOST contains 38 videos, all recorded outdoors in hot weather using long focal length settings. Each video includes instances of moving objects, such as vehicles, aircraft, and pedestrians. To provide accurate per-frame ground truth segmentation masks, manual annotations have been applied to the dataset.

The videos were recorded using a Nikon Coolpix P1000, a camera with an adjustable focal length of up to 539 mm (125× optical zoom), equivalent to a 3000 mm focal length in a 35 mm sensor format. The videos have a resolution of 1920×1080. In total, the dataset comprises 38 videos with 1719 frames. Moving objects in each frame were annotated using the Computer Vision Annotation Tool (CVAT). This dataset is the first to provide ground truth (GT) moving object segmentation masks for long-range turbulent video analysis.

Although DOST is primarily designed for motion segmentation, it can also be applied to other tasks, such as turbulent video restoration. Table 1 at element 705 presents a comparison between DOST and existing datasets intended for turbulent image or video processing. Acquiring real images or videos affected by air turbulence presents significant challenges, making real datasets scarce and typically small in size. Some existing datasets have been synthesized using turbulence simulators applied to standard image datasets. However, there exists a domain gap between simulated and real data.

Additionally, previous real turbulent video datasets have been developed primarily for restoration tasks. While some datasets include bounding box annotations, none provide object-tight segmentation masks for motion analysis.

### Quantitative Comparisons:

Table 2, set forth at element 805 of FIG. 8 presents quantitative comparison results, where all methods are evaluated on the DOST dataset. The videos are categorized into two sets, labeled as normal turbulence and severe turbulence, based on the observed turbulence strength. The described method demonstrates significantly higher motion segmentation accuracy compared to state-of-the-art approaches across varying turbulence intensities.

Under normal conditions, some existing methods achieve reasonable performance. However, the described method as applied by region growing segmentation framework 170 attains substantially higher scores across all metrics. Compared to TMO, which achieves the highest overall score among the three state-of-the-art methods, accuracy utilizing region growing segmentation framework 170 increases by 60.1% in J and 34.9% in F. Under severe turbulence conditions, the performance of all state-of-the-art methods declines significantly, with J values falling below 0.25 and F values below 0.35. In contrast, region growing segmentation framework 170 results are robust to strong turbulence.

Implementation Details: The network of region growing segmentation framework 170 utilized for experimentation was implemented using PyTorch on a supercomputing node equipped with an NVIDIA GTX A100 GPU. Input frames were resized to a lower resolution of 240×432 to enable faster optical flow computation and network training. Optical flow estimation was performed using RAFT, with a maximum frame interval of 4. The stabilized optical flow and Sampson distance maps are subsequently computed based on the RAFT output. RAFT (Recurrent All-Pairs Field Transforms) is a deep learning-based optical flow estimation model that computes dense pixel correspondences between consecutive frames using an iterative refinement process for improved accuracy and robustness.

The stopping threshold δ_{seed} for the region-growing algorithm (referenced in Equation 3 above) is adjusted according to turbulence intensity to account for varying levels of turbulence across different videos. For bidirectional consistency losses, comparisons are made with four neighboring time frames, where g∈{−2, −1, 1, 2}, as specified in Equations 7 and 8.

Evaluation Metrics: To assess segmentation accuracy, the estimated segmentation masks were evaluated using two standard metrics. The first metric, Jaccard's Index ( [symbol] ), calculates the intersection-over-union (IoU) between two sets. The second metric, F1-Score ( [symbol] ), determines the harmonic mean of precision and recall, also referred to as the Dice coefficient. An overall performance metric, denoted as [symbol] , is computed by averaging ( [symbol] ) and ( [symbol] ).

Comparison with State-of-the-Art Methods: Application of region growing segmentation framework 170 was compared against recent state-of-the-art unsupervised motion segmentation techniques, including TMO, Deformable Sprites, and DS-Net, with the results provided by Table 2 of FIG. 8.

TMO achieved high accuracy in object segmentation regardless of motion, making it advantageous for handling turbulent videos despite not being explicitly designed for this purpose. Deformable Sprites integrated appearance features with optical flow while enforcing consistency through optical flow-guided grouping loss and warping loss. DS-Net leveraged multi-scale spatial and temporal features for segmentation and maintained strong performance, particularly when dealing with noisy inputs.

For all three methods, official code implementations were used, and networks were trained following the configurations described by their creators. For methods requiring optical flow, RAFT was employed to estimate optical flow between consecutive frames.

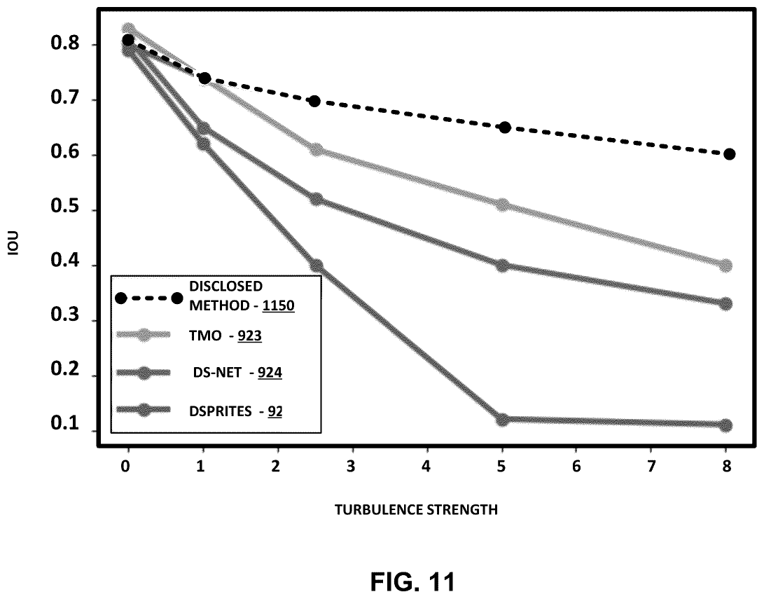

Further experimentation was conducted on a larger synthetic dataset to evaluate robustness under varying turbulence intensities. A physics-based turbulence simulator and the DAVIS 2016 dataset were used to generate synthetic videos with different levels of turbulence. The three state-of-the-art methods were also tested on this synthetic dataset. [symbol] score (or IoU) relative to turbulence strength are presented in FIG. 11, described below. The results confirm that application of region growing segmentation framework 170 maintains robustness under different turbulence conditions. When no turbulence is present in the scene (strength=0), TMO achieves a slightly higher [symbol] score due to incorporating more visual cues for segmentation, whereas region growing segmentation framework 170 better addresses turbulence-related artifacts.

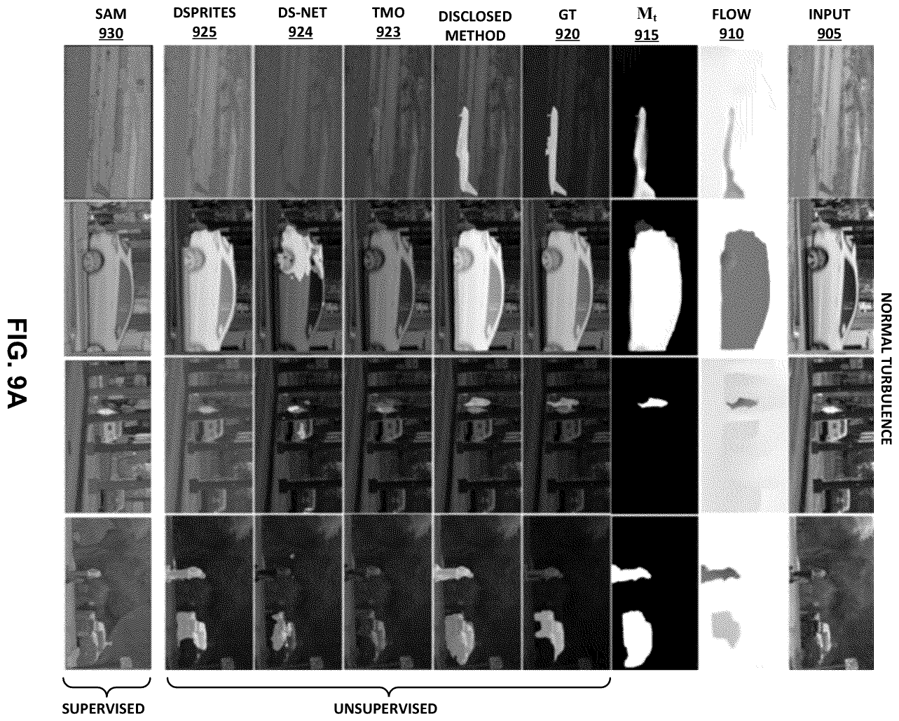

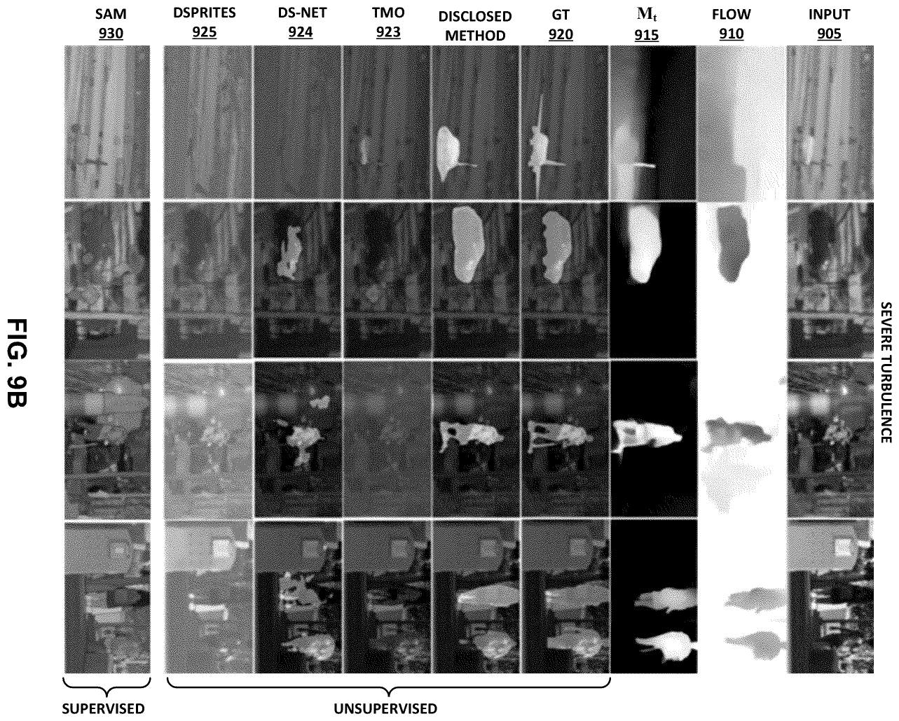

FIGS. 9A and 9B depicts qualitative comparisons with state-of-the-art methods on Dynamic Object Segmentation in Turbulence (DOST) with respect to various turbulence strengths, in accordance with aspects of the disclosure. Additionally depicted by FIGS. 9A and 9B are raw optical flows (“Flow”) 910, motion feature maps (“Mₜ”) 915, and ground truth masks (“GT”) 920.

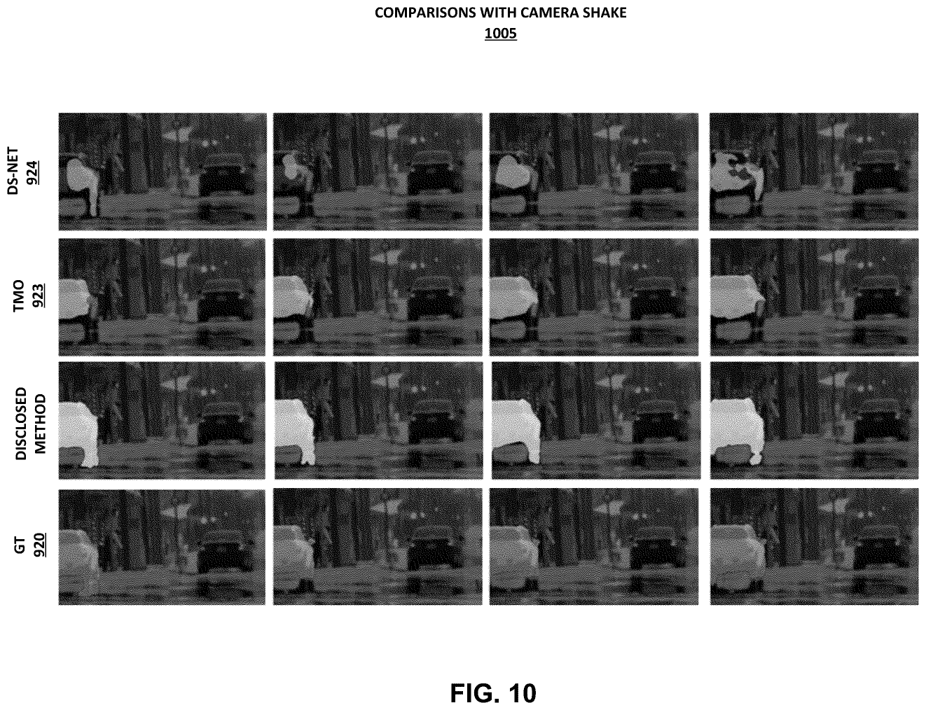

FIG. 10 depicts example results of handling videos including comparisons with camera shake 1005, in accordance with aspects of the disclosure.

FIG. 11 depicts example results of handling videos including comparisons with turbulence strength 1105, in accordance with aspects of the disclosure.

The results provided by FIGS. 10 and 11 show robust performance on different time frames (refer to the 2nd to 4th columns of FIG. 10) in videos suffering from significant camera shake. The results provided by FIGS. 10 and 11 also show that application of region growing segmentation framework 170 achieves the best robustness across different

turbulence strengths, even when very strong (refer to FIG. 11 depicting superior results for disclosed method 1150).

Qualitative Comparisons: Visual comparisons with state-of-the-art methods are presented in FIGS. 9A and 9B which illustrate how optical flow estimations are significantly impacted by turbulence, particularly in severe cases. Region growing segmentation framework 170 successfully generates segmentation masks that closely align with object boundaries while effectively handling multiple moving objects.

State-of-the-art methods encounter difficulties when turbulence intensity is high or when moving objects are small with segmentation masks remaining incomplete in many cases. In the airplane scenes (leftmost column of FIGS. 9A and 9B), each of DS-Net 924 and DSprites 925 (Deformable Sprites) fail to detect moving objects. Notably, region growing segmentation framework 170 demonstrates the highest robustness to turbulence-induced distortions and camera shake, as illustrated by the comparisons with camera shake 1005 at FIG. 10 providing the impact of various camera motions, including complex multi-directional shake, on segmentation results is analyzed in video sequences.

Quantitatively, region growing segmentation framework 170 achieves an average IoU score of 0.712 on videos affected by camera shake in the dataset, outperforming TMO 923 (0.305), DS-Net (0.267), and Deformable Sprites (0.235).

Supervised segmentation methods exhibit difficulty in generalizing to the DOST dataset, as they are trained exclusively on turbulence-free data. For example, the segmentation foundation model SAM 930, despite being trained on 11 million images and over 1 billion masks, fails to segment entire objects under strong turbulence, as shown in FIGS. 9A and 9B (bottom row). Additionally, SAM 930 does not interpret motion and requires user interaction through clicks or prompts, whereas the described method segments moving objects without requiring any user input. SAM (Segment Anything Model) is a foundation model for image segmentation enabling prompt-based segmentation but lacking inherent motion understanding or turbulence robustness.

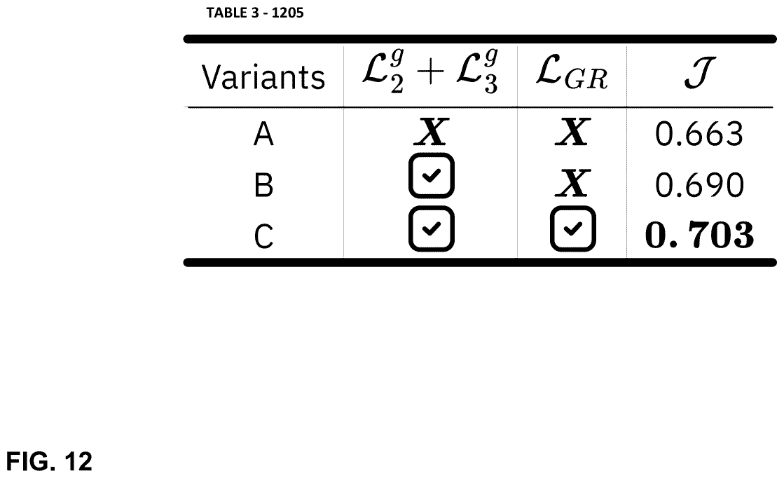

FIG. 12 illustrates Table 3 at element 1205 which provides results of ablation studies for different variants of the network as applied by region growing segmentation framework 170, in accordance with aspects of the disclosure. In particular, variant A depicts simply utilizing region-growing. Variant B depicts a full pipeline without grouping loss. Variant C depicts the full pipeline of region growing segmentation framework 170.

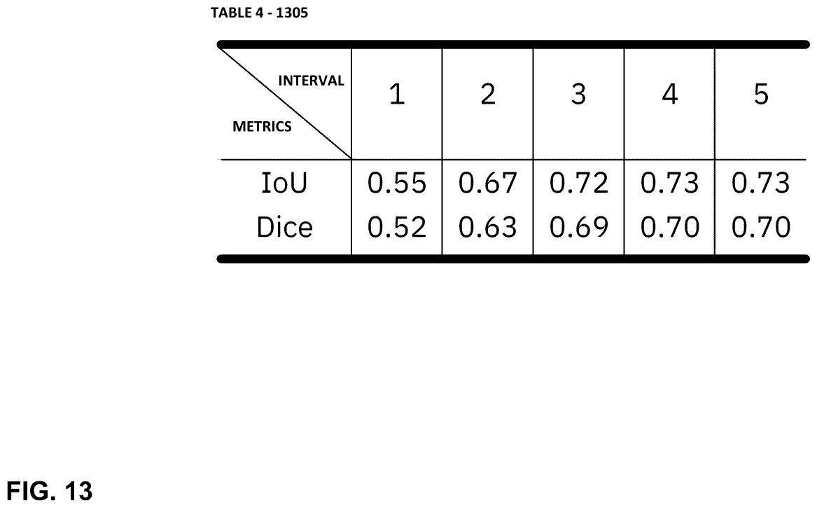

FIG. 13 illustrates Table 4 at element 1305 which provides results of ablation studies for different intervals, in accordance with aspects of the disclosure. In particular, the interval i=1 . . . 5 is the maximum temporal gap used to stabilize optical flow, as provided by Equation 1 above.

Ablation Studies: Ablation studies were conducted to evaluate individual components of the described method. All experiments are performed using the DOST dataset. Three variations of the method are tested: Variation A applies only the region-growing algorithm, with Refine-Net excluded. Variation B incorporates both region-growing and Refine-Net but removes the grouping loss for refinement. Variation C implements the complete approach. [symbol] score comparison results are presented in FIG. 12. Each component contributes to improved performance, with the full model of region growing segmentation framework 170 demonstrating the highest accuracy.

The influence of optical flow interval length, defined as the number of temporal frames used for optical flow computation, was also examined. Accuracy scores in relation to interval length are shown in FIG. 13. The results indicate that performance stabilizes once the interval exceeds 4. Based on this observation, the interval was set to 4.

Further evaluation was performed on the effectiveness of optical flow stabilization and the geometric consistency check. Removing the optical flow stabilization step results in an IoU score reduction to 0.354. Excluding the geometric consistency check lowers the IoU to 0.685, whereas the full pipeline achieves an IoU of 0.703.

FIG. 14 illustrates Algorithm 1 at element 1405 which provides example operations for Region Growing Segmentation (RGS), in accordance with aspects of the disclosure.

According to at least one example, region growing segmentation framework 170 may apply Algorithm 1 to generate coarse segmentation masks from input motion feature maps and sliding window operations. The algorithm begins with the inputs {Mₜ}ₜ₌₁^{T}, representing motion feature maps across frames, {Wₖ}ₖ₌₁^{T} (sliding window), and an object seed ID m initialized to 0. The output is specified as coarse masks {βₜ^{m}}ₜ₌₁^{T} for each frame t.

The process iterates over all frames t from 1 to T, and for each frame, iterates over all sliding windows k from 1 to K. Within each sliding window, the algorithm evaluates every pixel p within the motion feature map Mₜ. If the variance of the pixel values in the motion map, denoted as σ²(Mₜ(p)|p∈Wₖ)≤8, within the window Wₖ is less than or equal to a threshold δ, the pixel is assigned as an object seed m, and the region-growing algorithm (RGA) is initiated to generate the coarse mask βₜ^{m}. Pixels not meeting the threshold are set as background, and the loop for the current sliding window is exited. Otherwise, the loop continues evaluating remaining pixels.

Once all pixels in the motion feature map are evaluated, the coarse mask Bar is returned, and the object seed ID m is incremented. This process is repeated for all frames, and the output {βₜ^{m}} is collected for all T frames.

After the region-growing process, a motion feature temporal alignment (MFTA) step and a mask smoothing (MS) step are applied to refine and align the coarse masks. The algorithm concludes by returning the refined masks {βₜ^{m}} for all frames.

This structured methodology enables precise segmentation by leveraging motion feature maps, threshold evaluation, and refinement techniques.

Mask Filtering and Temporal Alignment (MFTA): As discussed above, for each frame, the region-growing algorithm (RGA) may generate a mask with an ID ranging from 1 to K, where K denotes the maximum number of moving objects in the video. To determine cohesive IDs, the physical centers of each of the masks may be computed utilizing an iterative process that minimizes the within-cluster sum of squares to determine K-means centroids μ^{m} according to equation 4, as discussed above.

Masks may be categorized by comparing their centers to the centroids such that masks that are spatially coherent through frames receive a consistent ID, unifying the representation of each moving object across the video's duration.

Mask Stabilization (MS): Even after filtering through MFTA, the masks, denoted as βₜ^{m}, may exhibit noise and imprecise boundaries. An average mask may therefore be applied as a thresholding reference to generate the output masks for RGS as discussed above.

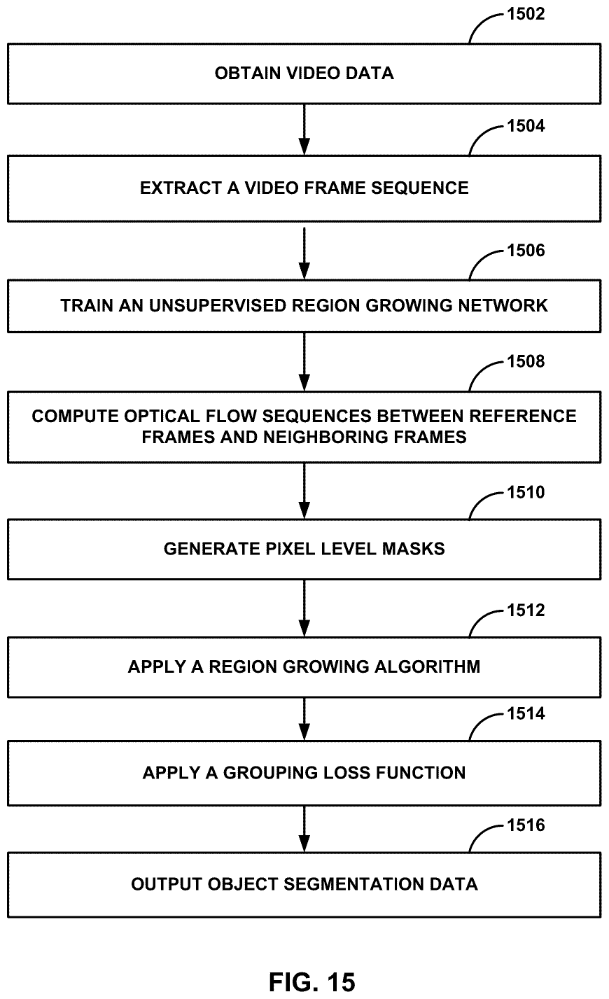

FIG. 15 is a flow diagram illustrating an example method for implementing an unsupervised region-growing network for use with object segmentation in atmospheric turbulence, in accordance with one or more techniques of this disclosure. FIG. 15 is described with respect to computing device 100, operating system 114, and applications 116 of FIG. 1, the conceptual framework of FIG. 2, Unsupervised Region-Growing Network (URG-Net) 399 pipeline discussed in relation to FIGS. 3A and 3B, pipeline of epipolar geometry-based motion disentanglement 405 of FIGS. 4A and 4B, intermediate results for motion feature map estimation 505 of FIG. 5, pipeline of region growing-based segmentation 605 of FIG. 6, and the concepts discussed in relation to FIGS. 7, 8, 9A, 9B, 10, 11, 12, 13, and 14. However, the techniques of FIG. 15 may be performed by different components of computing device 100 or by additional or alternative systems.

Processing circuitry of computing device 100 may be configured to obtain video data (1502). For example, processing circuitry may be configured to obtain input data including the video data degraded by atmospheric turbulence.

Processing circuitry of computing device 100 may be configured to extract a video frame sequence (1504). For example, processing circuitry may be configured to extract a video frame sequence from the video data.

Processing circuitry of computing device 100 may be configured to train an unsupervised region growing network (1506). For example, processing circuitry may be configured to train, by a computer, the unsupervised Region-Growing Network (RGN) based on the input data and a selected training algorithm to generate a trained RGN, wherein the selected training algorithm includes a region-growing algorithm and a grouping loss function.

Processing circuitry of computing device 100 may be configured to compute optical flow sequences between reference frames and neighboring frames (1508). For example, processing circuitry may be configured to for each of a plurality of reference frames within the video frame sequence, compute a bidirectional optical flow sequence between the reference frame and any neighboring frame of the reference frame within the video frame sequence.

Processing circuitry of computing device 100 may be configured to generate pixel-level masks (1510). For example, processing circuitry may be configured to generate pixel-level masks for any moving object identified within the video frame sequence.

Processing circuitry of computing device 100 may be configured to apply a region growing algorithm (1512). For example, processing circuitry may be configured to apply the region-growing algorithm to generate a coarse mask for each moving object from the pixel-level masks generated for any moving object identified within the video frame sequence.

Processing circuitry of computing device 100 may be configured to apply a grouping loss function (1514). For example, processing circuitry may be configured to apply the grouping loss function to the coarse mask generated for each moving object to generate refined masks consistent across consecutive frames of the video frame sequence corresponding to each coarse mask.

Processing circuitry of computing device 100 may be configured to output object segmentation data (1516). For example, processing circuitry may be configured to output, using the trained RGN, the refined masks as object segmentation data for the video data received.

In such a way, a two-stage unsupervised method for segmenting foreground objects in turbulence-impacted videos is provided and experimentally validated as superior to other known methodologies. By leveraging optimized optical flow and region growing techniques, the disclosed methodology generates and refines coarse masks to overcome atmospheric turbulence challenges, and in so doing, achieves significant performance enhancements of over 20% when compared with other unsupervised techniques.

Additionally provided is the unique dataset utilized for the experiments described herein which is tailored for turbulence-affected video segmentation.

This disclosure includes the following examples.

Example 1—A method of using an unsupervised region-growing network to perform object segmentation for video data degraded by atmospheric turbulence, comprising: obtaining input data including the video data degraded by the atmospheric turbulence; extracting a video frame sequence from the video data; training, by a computer, an unsupervised Region-Growing Network (RGN) based on the input data and a selected training algorithm to generate a trained RGN, wherein the selected training algorithm includes a region-growing algorithm and a grouping loss function; for each of a plurality of reference frames within the video frame sequence, computing a bidirectional optical flow sequence between the reference frame and any neighboring frame of the reference frame within the video frame sequence; generating pixel-level masks for any moving object identified within the video frame sequence; applying the region-growing algorithm to generate a coarse mask for each moving object from the pixel-level masks generated for any moving object identified within the video frame sequence; applying the grouping loss function to the coarse mask generated for each moving object to generate refined masks consistent across consecutive frames of the video frame sequence corresponding to each coarse mask; and outputting, using the trained RGN, the refined masks as object segmentation data for the video data received.

Example 2—The method of example 1, further comprising: capturing long-range imaging video data at a time and place exhibiting environmental atmospheric turbulence which satisfies a threshold atmospheric turbulence condition.

Example 3—The method of examples 1 or 2, wherein the method further comprises: generating a coarse map from the coarse masks generated for each moving object; and incorporating a grouping loss function to rectify one or more errors in the coarse map.

Example 4—The method of any of examples 1-3, wherein the method further comprises: grouping nearby pixels within the coarse masks across multiple frames of the video frame sequence together to reduce gaps between the nearby pixels.

Example 5—The method of any of examples 1-4, wherein the method further comprises: grouping nearby pixels within the coarse masks across multiple frames of the video frame sequence together to eliminate one or more segment errors between the multiple frames of the video frame sequence.

Example 6—The method of any of examples 1-5, wherein the method further comprises: utilizing the refine-net, optimizing the coarse masks generated for each moving object for spatial-context and consistency across consecutive frames within the video frame sequence to generate the refined masks.

Example 7—The method of any of examples 1-6, wherein the method further comprises: generating motion feature maps using an epipolar geometry-based consistency check to distinguish between rigid object motion and turbulence-induced or camera-induced motion.

Example 8—The method of any of examples 1-7, wherein the method further comprises: stabilizing optical flow estimations by averaging bidirectional optical flow sequences within a short temporal interval to reduce errors introduced by atmospheric turbulence while preserving features of rigid motion.

Example 9—The method of any of examples 1-8, wherein the method further comprises: distinguishing moving objects from a static background using a Sampson distance map computed based on fundamental matrices derived from a stabilized optical flow that quantifies geometric consistency errors associated with the moving objects.

Example 10—The method of any of examples 1-9, wherein the method further comprises: utilizing a detect-then-grow function to segment moving objects, wherein the detect-then-grow function includes at least: selecting seedling pixels from motion feature maps; and expanding segmentation masks using a region-growing algorithm.

Example 11—A system comprising: processing circuitry; non-transitory computer readable media; and instructions that, when executed by the processing circuitry, configure the processing circuitry to: obtain input data including video data degraded by atmospheric turbulence; extract a video frame sequence from the video data; train, by a computer, an unsupervised Region-Growing Network (RGN) based on the input data and a selected training algorithm to generate a trained RGN, wherein the selected training algorithm includes a region-growing algorithm and a grouping loss function; for each of a plurality of reference frames within the video frame sequence, compute a bidirectional optical flow sequence between the reference frame and any neighboring frame of the reference frame within the video frame sequence; generate pixel-level masks for any moving object identified within the video frame sequence; apply the region-growing algorithm to generate a coarse mask for each moving object from the pixel-level masks generated for any moving object identified within the video frame sequence; apply the grouping loss function to the coarse mask generated for each moving object to generate refined masks consistent across consecutive frames of the video frame sequence corresponding to each coarse mask; and output, using the trained RGN, the refined masks as object segmentation data for the video data received.

Example 12—The system of example 11, wherein the instructions configure the processing circuitry to: capture long-range imaging video data at a time and place exhibiting environmental atmospheric turbulence which satisfies a threshold atmospheric turbulence condition.

Example 13—The system of examples 11 or 12, wherein the instructions configure the processing circuitry to: generate a coarse map from the coarse masks generated for each moving object; and incorporate a grouping loss function to rectify one or more errors in the coarse map.

Example 14—The system of any of examples 11-13, wherein the instructions configure the processing circuitry to: group nearby pixels within the coarse masks across multiple frames of the video frame sequence together to reduce gaps between the nearby pixels.

Example 15—The system of any of examples 11-14, wherein the instructions configure the processing circuitry to: group nearby pixels within the coarse masks across multiple frames of the video frame sequence together to eliminate one or more segment errors between the multiple frames of the video frame sequence.

Example 16—The system of any of examples 11-15, wherein the instructions configure the processing circuitry to: optimize, via the refine-net, the coarse masks generated for each moving object for spatial-context and consistency across consecutive frames within the video frame sequence to generate the refined masks.

Example 17—The system of any of examples 11-16, wherein the instructions configure the processing circuitry to: generating motion feature maps using an epipolar geometry-based consistency check to distinguish between rigid object motion and turbulence-induced or camera-induced motion.

Example 18—The system of any of examples 11-17, wherein the instructions configure the processing circuitry to: stabilizing optical flow estimations by averaging bidirectional optical flow sequences within a short temporal interval to reduce errors introduced by atmospheric turbulence while preserving features of rigid motion.

Example 19—The system of any of examples 11-18, wherein the instructions configure the processing circuitry to: distinguishing moving objects from a static background using a Sampson distance map computed based on fundamental matrices derived from a stabilized optical flow that quantifies geometric consistency errors associated with the moving objects.

Example 20—Computer-readable storage media comprising instructions that, when executed, configure processing circuitry to: obtain input data including video data degraded by atmospheric turbulence; extract a video frame sequence from the video data; train, by a computer, an unsupervised Region-Growing Network (RGN) based on the input data and a selected training algorithm to generate a trained RGN, wherein the selected training algorithm includes a region-growing algorithm and a grouping loss function: for each of a plurality of reference frames within the video frame sequence, compute a bidirectional optical flow sequence between the reference frame and any neighboring frame of the reference frame within the video frame sequence; generate pixel-level masks for any moving object identified within the video frame sequence; apply the region-growing algorithm to generate a coarse mask for each moving object from the pixel-level masks generated for any moving object identified within the video frame sequence; apply the grouping loss function to the coarse mask generated for each moving object to generate refined masks consistent across consecutive frames of the video frame sequence corresponding to each coarse mask; and output, using the trained RGN, the refined masks as object segmentation data for the video data received.

Example 21—A computer program product comprising one or more instructions that, when executed by at least one processor, cause the at least one processor to perform any of the methods of examples 1-10.

Example 22—A device comprising means for performing any of the methods of examples 1-10.

It is to be recognized that depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of using an unsupervised region-growing network to perform object segmentation for video data degraded by atmospheric turbulence, comprising:
obtaining input data including the video data degraded by the atmospheric turbulence;
extracting a video frame sequence from the video data;
training, by a computer, an unsupervised Region-Growing Network (RGN) based on the input data and a selected training algorithm to generate a trained RGN, wherein the selected training algorithm includes a region-growing algorithm and a grouping loss function:
for each of a plurality of reference frames within the video frame sequence, computing a bidirectional optical flow sequence between the reference frame and any neighboring frame of the reference frame within the video frame sequence;
generating pixel-level masks for any moving object identified within the video frame sequence;
applying the region-growing algorithm to generate a coarse mask for each moving object from the pixel-level masks generated for any moving object identified within the video frame sequence;
applying the grouping loss function to the coarse mask generated for each moving object to generate refined masks consistent across consecutive frames of the video frame sequence corresponding to each coarse mask; and
outputting, using the trained RGN, the refined masks as object segmentation data for the video data received.

2. The method of claim 1, further comprising:
capturing long-range imaging video data at a time and place exhibiting environmental atmospheric turbulence which satisfies a threshold atmospheric turbulence condition.

3. The method of claim 1, wherein the method further comprises:
generating a coarse map from the coarse masks generated for each moving object; and
incorporating a grouping loss function to rectify one or more errors in the coarse map.

4. The method of claim 1, wherein the method further comprises:
grouping nearby pixels within the coarse masks across multiple frames of the video frame sequence together to reduce gaps between the nearby pixels.

5. The method of claim 1, wherein the method further comprises:
grouping nearby pixels within the coarse masks across multiple frames of the video frame sequence together to eliminate one or more segment errors between the multiple frames of the video frame sequence.

6. The method of claim 1, wherein the method further comprises:
utilizing a refine-net, optimizing the coarse masks generated for each moving object for spatial-context and consistency across consecutive frames within the video frame sequence to generate the refined masks.

7. The method of claim 1, wherein the method further comprises:
generating motion feature maps using an epipolar geometry-based consistency check to distinguish between rigid object motion and turbulence-induced or camera-induced motion.

8. The method of claim 1, wherein the method further comprises:
stabilizing optical flow estimations by averaging bidirectional optical flow sequences within a short temporal interval to reduce errors introduced by atmospheric turbulence while preserving features of rigid motion.

9. The method of claim 1, wherein the method further comprises:
distinguishing moving objects from a static background using a Sampson distance map computed based on fundamental matrices derived from a stabilized optical flow that quantifies geometric consistency errors associated with the moving objects.

10. The method of claim 1, wherein the method further comprises:
utilizing a detect-then-grow function to segment moving objects, wherein the detect-then-grow function includes at least:
selecting seedling pixels from motion feature maps; and
expanding segmentation masks using a region-growing algorithm.

11. A system comprising:
processing circuitry;
non-transitory computer readable media; and
instructions that, when executed by the processing circuitry, configure the processing circuitry to:
obtain input data including video data degraded by atmospheric turbulence;
extract a video frame sequence from the video data;
train, by a computer, an unsupervised Region-Growing Network (RGN) based on the input data and a selected training algorithm to generate a trained RGN, wherein the selected training algorithm includes a region-growing algorithm and a grouping loss function:
for each of a plurality of reference frames within the video frame sequence, compute a bidirectional optical flow sequence between the reference frame and any neighboring frame of the reference frame within the video frame sequence;
generate pixel-level masks for any moving object identified within the video frame sequence;
apply the region-growing algorithm to generate a coarse mask for each moving object from the pixel-level masks generated for any moving object identified within the video frame sequence;
apply the grouping loss function to the coarse mask generated for each moving object to generate refined masks consistent across consecutive frames of the video frame sequence corresponding to each coarse mask; and
output, using the trained RGN, the refined masks as object segmentation data for the video data received.

12. The system of claim 11, wherein the instructions configure the processing circuitry to:
capture long-range imaging video data at a time and place exhibiting environmental atmospheric turbulence which satisfies a threshold atmospheric turbulence condition.

13. The system of claim 11, wherein the instructions configure the processing circuitry to:
generate a coarse map from the coarse masks generated for each moving object; and
incorporate a grouping loss function to rectify one or more errors in the coarse map.

14. The system of claim 11, wherein the instructions configure the processing circuitry to:
group nearby pixels within the coarse masks across multiple frames of the video frame sequence together to reduce gaps between the nearby pixels.

15. The system of claim 11, wherein the instructions configure the processing circuitry to:
group nearby pixels within the coarse masks across multiple frames of the video frame sequence together to eliminate one or more segment errors between the multiple frames of the video frame sequence.

16. The system of claim 11, wherein the instructions configure the processing circuitry to:
optimize, a refine-net, the coarse masks generated for each moving object for spatial-context and consistency across consecutive frames within the video frame sequence to generate the refined masks.

17. The system of claim 11, wherein the instructions configure the processing circuitry to:
generating motion feature maps using an epipolar geometry-based consistency check to distinguish between rigid object motion and turbulence-induced or camera-induced motion.

18. The system of claim 11, wherein the instructions configure the processing circuitry to:
stabilizing optical flow estimations by averaging bidirectional optical flow sequences within a short temporal interval to reduce errors introduced by atmospheric turbulence while preserving features of rigid motion.

19. The system of claim 11, wherein the instructions configure the processing circuitry to:
distinguishing moving objects from a static background using a Sampson distance map computed based on fundamental matrices derived from a stabilized optical flow that quantifies geometric consistency errors associated with the moving objects.

20. Computer-readable storage media comprising instructions that, when executed, configure processing circuitry to:
obtain input data including video data degraded by atmospheric turbulence;
extract a video frame sequence from the video data;
train, by a computer, an unsupervised Region-Growing Network (RGN) based on the input data and a selected training algorithm to generate a trained RGN, wherein the selected training algorithm includes a region-growing algorithm and a grouping loss function:
for each of a plurality of reference frames within the video frame sequence, compute a bidirectional optical flow sequence between the reference frame and any neighboring frame of the reference frame within the video frame sequence;
generate pixel-level masks for any moving object identified within the video frame sequence;
apply the region-growing algorithm to generate a coarse mask for each moving object from the pixel-level masks generated for any moving object identified within the video frame sequence;
apply the grouping loss function to the coarse mask generated for each moving object to generate refined masks consistent across consecutive frames of the video frame sequence corresponding to each coarse mask; and
output, using the trained RGN, the refined masks as object segmentation data for the video data received.
